(19) United States
(12) Patent Application Publication
(10) Pub. No.: US 2008/0064805 A1
(43) Pub. Date: Mar. 13, 2008

(54) Process for producing injection molded product

(75) Inventors: Hirotaka Uosaki, Ichihara-shi (JP); Kuniaki Kawabe, Ichihara-shi (JP); Motoyasu Yasui, Chiba-shi (JP)

Correspondence Address: BUCHANAN, INGERSOLL & ROONEY PC, POST OFFICE BOX 1404, ALEXANDRIA, VA, 22313-1404, US

(73) Assignee: MITSUI CHEMICALS, INC., Minato-ku (JP)

(21) Appl. No.: 11/806,416

(22) Filed: May 31, 2007

Related U.S. Application Data
(63) Continuation-in-part of application No. 11/543,901, filed on Oct. 6, 2006.
(60) Provisional application No. 60/738,586, filed on Nov. 22, 2005.

(30) Foreign Application Priority Data
Oct. 7, 2005 (JP) 2005-295663

(51) Int. Cl. B29C 45/00

(52) U.S. Cl. 524/487; 264/299

(57) ABSTRACT

The present invention provides a process for producing an injection molded product comprising injection molding a mixture containing a thermoplastic resin (A) and a polyolefin wax (B),
wherein the mixture has L/L₀≧1.05, the L being a flow length in the case where the mixture contains the polyolefin wax and the L₀ being a flow length in the case where the mixture contains no polyolefin wax, the L and L₀ being measured under the conditions of a mold temperature of 40° C. and a resin temperature, Tr, as determined by the following expression:
   Tr=3/4×Tm+100 (wherein Tm represents a melting temperature (° C.) of the thermoplastic resin), using a spiral flow mold having a thickness of 1 mm and a width of 10 mm. According to the invention, by adding the polyolefin wax, a flow length of a thermoplastic resin can be lengthened, and releasability can be improved, and thus the thermoplastic resin can be thin molded or precision molded by injection molded without deteriorating the characteristics of the molded product to be obtained.

### BACKGROUND OF THE INVENTION

1. Field of the Invention

The present invention relates to a process for producing an injection molded product using a thermoplastic resin. More specifically, the present invention relates to a process for producing an injection molded product using a mixture containing a thermoplastic resin such as polyolefin resin and a polyolefin wax.

2. Description of the Related Art

The thermoplastic resin such as polyethylene and polypropylene is a resin having fluidity as a result of plasticization by means of heating, and is used to produce a variety of molded articles using various molding processes, for example, injection molding. In addition, a polypropylene resin mixture in which olefin elastomer is added to polypropylene is used to produce a variety of molded articles using various molding process, for example, injection molding. These molded articles are applied for various uses.

In general, if the thermoplastic resin is injection molded, it is necessary to give sufficient fluidity to the thermoplastic resin in order to prevent a short shot. In resent years, thus improvement of productivity in the injection molding is more strongly desired. If the thermoplastic resin is thin molded or precision molded by injection molding, problems that the molded article adheres to the mold, or the shape of the mold is not sufficiently expressed to the details may occur. For this reason, the releasability or the fluidity of the thermoplastic resin has greatly influenced the productivity of the injection molding of the thermoplastic resin, in particular, the production rate.

As the general process for giving sufficient fluidity to the thermoplastic resin and improving the productivity in a molding such as the injection molding, the process for molding comprising an addition of a plasticizer or a lubricant to the thermoplastic resin has been known. For example, the process for molding comprising an application of a molding auxiliary such as oil and polyethylene wax to the thermoplastic resin to be molded is examined (refer to, for example, JP-B No. 5-80492 and JP-T No. 2003-528948).

However, there is a case that the moldability itself tends to improve, but the properties of the molded articles such as a mechanical strength, a heat resistance, an impact resistance, heat disportion properties are deteriorated, even if the thermoplastic resin such as polyethylene is injection molded using conventional molding auxiliary. In addition, such the plasticizer or lubricant improves moldability, while it has a drawback that it lowers the characteristics, in particular, the mechanical strength or the heat resistance of the molded article. For this reason, there is suggested a thermoplastic resin composition to improve releasability or fluidity in the injection molding of the thermoplastic resin and to prevent the reduction of the characteristics of the molded article (refer to, for example, JP-A Nos. 5-209129, 9-111067, 2000-226478, and 2004-189864).

As the process adding no plasticizer and lubricant, the process comprising sufficiently plasticizing the thermoplastic resin at high molding temperature, and injection molding has been known. However, in the process, there are problems such as a burn of the resin due to high molding temperature, and deterioration due to heating. In addition, there is a problem that the productivity is lowered because that when continuously injection molded, the mold needs to be cooled, but it takes time to cool at high molding temperature. From the reason, heretofore, the method increasing power of a cooling device has been employed to reduce the cooling time, but it is not economically preferable, because of the need for new investment.

### SUMMARY OF THE INVENTION

The present invention is intended to solve the problems accompanied by the related art, and has an object to provide an injection molding process of a thermoplastic resin which is capable of thin molding or precision molding by improving injection moldability, particularly releasability or fluidity, without deteriorating the characteristics of the injection molded article of the thermoplastic resin.

In addition, the present invention is intended to solve the problem accompanied by the related art, and has an object to provide a process for injection molding of the thermoplastic resin such as polyethylene, polypropylene, and a mixture of polypropylene and olefin elastomer, capable of preventing a burn of the resin in an injection molding of the thermoplastic resin such as a polyolefin resin, and reducing the cooling time after injection; and a process for producing a molded product capable of improving the productivity without losing a moldability upon the injection molding, and not losing the properties of which the thermoplastic resin is originally has, for example, a mechanical characteristic, and a heat disportion.

The present inventors have earnestly studied to overcome the above-described problems, and as a result, they have found that a thermoplastic resin can be thin molded or precision molded by mixing a polyolefin wax with the thermoplastic resin to prepare a mixture comprising the thermoplastic resin and a polyolefin wax and having a longer flow length than the thermoplastic resin and excellent releasability, and by subjecting the mixture to injection molding, and that the injection molding is possible at the lower molding temperature than heretofore and the molded article having similar properties as the molded article obtained by using no plasticizer such as lubricant is obtained by injection molding using the thermoplastic resin such as polyolefin resin and specific polyethylene wax as a raw material, the productivity is improved without losing a moldability, and the properties of the molded product is not lost. The finding leads to completion of the present invention.

Specifically, the process for producing an injection molded article according to the present invention comprises injection molding a mixture containing a thermoplastic resin and a polyolefin wax, wherein the mixture has L/L₀≧1.05, the L being a flow length in the case where the mixture contains the polyolefin wax and the L₀ being a flow length in the case where the mixture contains no polyolefin wax, the L and L₀ being measured under the conditions of a mold temperature of 40° C. and a resin temperature, Tr, as determined by the following expression:
Tr=3/4×Tm+100

(wherein Tm represents a melting temperature (° C.) of the thermoplastic resin) using a spiral flow mold having a thickness of 1 mm and a width of 10 mm.

In the above production process, the polyolefin wax is preferably contained in an amount of 0.5 to 15 parts by weight based on 100 parts by weight of the thermoplastic resin. The polyolefin wax is preferably a polyethylene wax, and the thermoplastic resin is preferably polypropylene or polyethylene.

The process for producing the molded product of the invention is comprised of injection molding a mixture containing a thermoplastic resin (A) and a polyethylene wax having a density as measured by the density gradient tube process of JIS K7112 in the range of 880 to 980 (kg/m³) and a number-average molecular weight (Mn) in terms of polyethylene as measured by gel permeation chromatography (GPC) in the range of usually 500 to 4,000, and satisfying the relation represented by following expression (I):
B≦0.0075×K (I)

(wherein B is a content ratio (% by weight) on the basis of the weight of such content that the molecular weight in terms of polyethylene in the polylethylene wax as measured by gel permeation chromatography (GPC) become 20,000 or more, and K is a melt viscosity (mPa·s) at 140° C. of the polyethylene wax).

In addition, it is preferable that the polyethylene wax further satisfies the relation represented by following expression (II):
A≦230×K^{(-0.537)} (II)

(wherein A is the content ratio (% by weight) on the basis of the weight of the component having a molecular weight of 1,000 or less in terms of polyethylene in the polyethylene wax, as measured by gel permeation chromatography, and K is a melt viscosity (mPa·S) at 140° C. of the polyethylene wax).

It is one of preferred embodiment that when the thermoplastic resin (A) is polyethylene having a density as measured in accordance with the density gradient tube process of JIS K7112 in the range of 900 (kg/m³) or more to less than 940 (kg/m³), and an MI measured under the conditions at 190° C. and a test load of 21.18N in accordance with JIS K7210 in the range of 0.01 to 100 g/10 min., the polyethylene wax has a density as measured in accordance with the density gradient tube process of JIS K7112 in the range of 890 to 980 (kg/m³).

It is one of preferred embodiment that when the thermoplastic resin (A) is polyethylene having a density as measured in accordance with the density gradient tube process of JIS K7112 in the range of 940 to 980 (kg/m³), and an MI measured under the conditions at 190° C. and a test load of 21.18N in accordance with JIS K7210 in the range of 0.01 to 100 g/10 min., the polyethylene wax has a density as measured in accordance with the density gradient tube process of JIS K7112 in the range of 890 to 980 (kg/m³), and a number-average molecular weight (Mn) in terms of polyethylene as measured by gel permeation chromatography (GPC) in the range of usually 500 to 3,000.

It is one of preferred embodiment that when the thermoplastic resin (A) is polypropylene, the polyethylene wax has a density as measured in accordance with the density gradient tube process of JIS K7112 in the range of 890 to 980 (kg/m³).

It is one of preferred embodiment that the thermoplastic resin (A) is a resin mixture comprising 55 to 95% by weight of polypropylene and 5 to 45% by weight of an olefin elastomer, on the basis of 100% by weight of the total amount of polypropylene and olefin elastomer, and the polyethylene wax (B) has a density as measured in accordance with the density gradient tube process of JIS K7112 in the range of 880 to 920 (kg/m³).

It is preferable that 0.01 to 10 parts by weight of the polyethylene wax is contained based on 100 parts by weight of polyethylene in the mixture comprising the thermoplastic resin (A) and the polyethylene wax.

According to the present invention, a flow length of the thermoplastic resin can be longer and releasability can be improved by adding a polyolefin wax, and thus thin molding and precision molding is possible, without deteriorating the characteristic of the molded article to be obtained, by subjecting the thermoplastic resin to injection molding. In addition, according to the invention, the fluidity of the thermoplastic resin such as a polyolefin resin can be assured by adding a polyolefin wax such as polyethylene wax. As a result, the injection molding at low temperature become possible, and thus the burn in the injection molding of the resin can be prevented. Furthermore, in this case, sufficient fluidity can be obtained at low molding temperature compared to the case that the polyethylene wax is not contained, thus the resin can be sufficiently filled into the detail of a mold, and the short shot can be prevented. Furthermore, the deterioration of the properties of the molded article is not observed. In addition, the cooling time of the mold is reduced due to the low molding temperature, thus the molding cycle can be increased, and the improvement of the productivity in the existing facilities can be achieved.

Moreover, the producing process for the molded product of the invention give the excellent productivity without losing the moldability in the injection molding of the thermoplastic resin such as the polyolefin resin. Furthermore, as for the molded product of the thermoplastic resin such as the polyolefin resin obtained by the injection molding, the properties of which the thermoplastic resin itself such as the polyolefin resin originally has is not lost.

### DESCRIPTION OF THE PREFERRED EMBODIMENTS

Hereinafter, the present invention will be explained in detail.

Firstly, the raw material to be used in the injection molding of the invention will be explained.

[Thermoplastic Resin (A)]

Examples of the thermoplastic resin used in the present invention include polyolefin resins such as low-density polyethylenes such as linear low-density polyethylene, medium-density polyethylenes, high density polyethylenes, polypropylene, and an ethylene-propylene copolymer; olefin-vinyl compound copolymers such as an ethylene-acrylic acid copolymer, an ethylene-methacrylic acid copolymer or an esterification product thereof, an ethylene-vinyl acetate copolymer, and an ethylene-vinyl alcohol copolymer; polyvinyl chloride, polystyrene, polyester resins such as polyethylene terephthalate; and polyamide resins. Further, a graft copolymer, a block copolymer, or a random copolymer thereof can be used. In addition, these resins can be used in combination of two or more kinds.

[Polyolefin Resin]

In the invention, among the thermoplastic resin (A), a polyolefin resin is preferable. The polyolefin resin means a homopolymer or a copolymer of olefin and diolefin, or the mixture of these polymers. The polyolefin resins include polyethylene, polypropylene, olefin elastomer, and the mixture thereof.

The polyolefin resin typically has MI of 0.01 to 100 g/10 min measured under the conditions at 190° C. and a test load of 21.18N in accordance with JIS K7210.

The polyolefin resins include a homopolymer of ethylene or a copolymer of ethylene and α-olefin, or the blended product thereof (hereinafter may referred to as polyethylene (1)) of which the density is in the range of 900 (kg/m³) or more to less than 940 (kg/m³), and MI measured under the conditions at 190° C. and a test load of 21.18N in accordance with JIS K7210 is typically in the range of 0.01 to 100 g/10 min.

The polyolefin resins include a homopolymer of ethylene or a copolymer of ethylene and α-olefin, or the blended product thereof (hereinafter may referred to as polyethylene (2)) of which the density is in the range of 940 to 980 (kg/m³), and MI measured under the conditions at 190° C. and a test load of 21.18N in accordance with JIS K7210 is typically in the range of 0.01 to 100 g/10 min.

The polyolefin resins also include polypropylene.

The polyolefin resins include a resin mixture of polypropylene and olefin elastomer (hereinafter, may referred to as polypropylene resin mixture (1)). Hereinafter, these will be explained in detail.

[Polyethylene (1)]

The polyethylene is, specifically, a homopolymer of ethylene, a copolymer of ethylene and a small amount of α-olefin, or a blended product thereof, which generally has MI of 0.01 to 100 g/10 min measured under the conditions at 190° C. and a test load of 21.18N in accordance with JIS K7210.

The examples of the polyethylene (1) used in the invention is not limited as long as the density is in the range of 900 (kg/m³) or more to less than 940 (kg/m³). The specific example includes low-density polyethylene, medium-density polyethylenes, linear low-density polyethylene, ultralow-density polyethylene, or the blended product thereof.

In the invention, the measurement condition of the MI and the density of polyethylene are as follows.

(MI)

The MI is measured under the conditions at 190° C. and a test load of 21.18N in accordance with JIS K7210

(Density)

The density is measured in accordance with the density gradient tube process of JIS K7210.

As described above, the density of the polyethylene (1) is in the range of 900 (kg/m³) or more to less than 940 (kg/m³), but preferably in the range of 900 to 930 (kg/m³).

With the density of the polyethylene (1) in the above range, a molded product which is excellent in texture, rigidity, impact strength, and chemical resistance can be obtained.

The MI of the polyethylene (1) is preferably in the range of 0.1 to 30.0 g/10 min., and more preferably in the range of 0.5 to 15.0 g/10 min. With the MI of polyethylene in the above range, a molded product which has excellent balance between molding workability and mechanical strength, as well as excellent properties in texture, rigidity, impact strength, and chemical resistance can be obtained.

The shape of the polyethylene (1) is not limited, but is generally a particle in the state of a pellet or a tablet.

[Polyethylene (2)]

The examples of the polyethylene (2) used in the invention is not limited as long as the density is in the range of 940 to 980 (kg/m³). The specific example includes high-density polyethylene, or the blended product thereof.

As described above, the density of the polyethylene (2) is in the range of 940 to 980 (kg/m³), but preferably in the range of 950 to 980 (kg/m³).

With the density of the polyethylene (2) in the above range, a molded product which is excellent in texture, rigidity, impact strength, and chemical resistance can be obtained.

The MI of the polyethylene (2) is preferably in the range of 0.1 to 30.0 g/10 min., and more preferably in the range of 0.5 to 15.0 g/10 min. With the MI of polyethylene in the above range, a molded product which has excellent balance between molding workability and mechanical strength, as well as excellent properties in texture, rigidity, impact strength, and chemical resistance can be obtained.

Furthermore, the MI (190° C.) of the high density polyethylene is in preferable tendency in the range of 3.0 to 20 g/10 min., and in more preferable tendency in the range of 4.0 to 15 g/10 min., from the view point of obtaining the molded product which is excellent in texture, rigidity, impact strength, and chemical resistance.

Furthermore, the density of the high density polyethylene tends to be preferable in the range of 942 to 970 kg/m³, more preferable in the range of 950 to 965 kg/m³, from the view point of obtaining the molded product which is excellent in texture, rigidity, impact strength, and chemical resistance.

The shape of the polyethylene (2) is not limited, but is generally a particle in the state of a pellet or a tablet.

[Polypropylene]

In the invention, polypropylene means a homopolymer of propylene, a copolymer of propylene and α-olefin (except propylene), or a blend thereof, of which generally has MI of 0.01 to 100 g/10 min measured under the conditions at 230° C. and a test load of 21.18N in accordance with JIS K7210. Specific example of polypropylene includes propylene homopolymer, polypropylene block polymer and polypropylene random copolymer obtained by copolymerization of propylene and α-olefin (except propylene), and the blended product thereof.

In the invention, the measurement condition of the MI of polypropylene is as follows.

(MI)

The MI is measured under the conditions at 230° C. and a test load of 21.18N in accordance with JIS K7210.

The MI of the polypropylene is preferably in the range of 0.1 to 50.0 g/10 min., and more preferably in the range of 10.0 to 30.0 g/10 min. With the MI of polypropylene in the above range, a molded product which has excellent balance between molding workability and mechanical strength, as well as excellent properties in texture, rigidity, impact strength, and chemical resistance can be obtained.

The MI (230° C.) of the polypropylene is preferably in the range of 3.0 to 60 g/10 min., and more preferably in the range of 5.0 to 55 g/10 min., from the view point of obtaining the molded product which has excellent heat resistance, and rigidity.

The shape of the polyethylene is not limited, but is generally a particle in the state of a pellet or a tablet.

[Polypropylene Resin Mixture (1)]

A polypropylene resin mixture (1) of the invention is a resin mixture of polypropylene and olefin elastomer.

Polypropylene which is added to the polypropylene resin mixture (1) is same polypropylene as described above, wherein the density measured in accordance with the density gradient tube process of JIS K7112 is generally 910 (kg/m³) or more.

An olefin elastomer is added to the polypropylene resin mixture (1) in the present invention. The olefin elastomers include:

an ethylene.α-olefin random copolymer of which MI measured under the conditions at 190° C. and a test load of 21.18N in accordance with JIS K7112 is in the range of 0.01 to 100 g/10 min., and the density measured in accordance with the density gradient tube process of JIS K7112 is 850 (kg/m³) or more to less than 900 (kg/m³);

a propylene.α-olefin random copolymer of which MI measured under the conditions at 230° C. and a test load of 21.18N in accordance with JIS K7210 is in the range of 0.01 to 100 g/10 min., and the density measured in accordance with the density gradient tube process of JIS K7112 is 850 (kg/m³) or more to less than 910 (kg/m³);

an ethylene.α-olefin nonconjugated polyene random copolymer of which MI measured under the conditions at 190° C. and a test load of 21.18N in accordance with JIS K7210 is in the range of 0.01 to 100 g/10 min., and the density measured in accordance with the density gradient tube process of JIS K7112 is 850 (kg/m³) or more to less than 900 (kg/m³); and

the mixture thereof.

The ethylene.α-olefin random copolymer is generally a random copolymer of ethylene and α-olefin having 3 to 20 carbon atoms, and the ethylene.α-olefin random copolymer is a rubber. The α-olefins having 3 to 20 carbon atoms include propylene, 1-butene, 1-pentene, 1-hexene, 4-methyl-1-pentene, 1-heptene, 1-octnene, 1-decene, 1-dodecene, 1-tetradecene, 1-hexadecene, and 1-eicosene. Among the α-olefins, propylene, 1-butene, 1-hexene, and 1-octnene are preferable. The α-olefins may be used independently or in the combination of two or more.

The ethylene.α-olefin copolymer is generally a polymer obtained by copolymerization of ethylene in the range of 90 to 50% by mole, and α-olefin in the range of 10 to 50% by mole.

MI (JIS K7210: 190° C., test lode of 21.18N) is preferably in the range of 0.3 to 20 g/10 min. With the MI in the above range, a molded product which has excellent balance between molding processability and mechanical strength can be obtained.

The propylene.α-olefin random copolymer is generally a random copolymer of propylene and α-olefin having 4 to 20 carbon atoms, and the propylene.α-olefin random copolymer is a rubber. The α-olefins having 4 to 20 carbon atoms include, 1-butene, 1-pentene, 1-hexene, 4-methyl-1-pentene, 1-heptene, 1-octnene, 1-decene, 1-dodecene, 1-tetradecene, 1-hexadecene, and 1-eicosene. The α-olefin may be used independently or in the combination of two or more.

The propylene.α-olefin random copolymer is generally a polymer obtained by copolymerization of propylene in the range of 90 to 55% by mole, and α-olefin in the range of 10 to 45% by mole.

MI (JIS K7210: 230° C., test lode of 21.18N) is preferably in the range of 0.3 to 20 g/10 min. With the MI in the above range, a molded product which is excellent in the balance between molding processability and mechanical strength can be obtained.

The ethylene.α-olefin.nonconjugated polyene random copolymer is generally a random copolymer of ethylene, α-olefin having 3 to 20 carbon atoms, and conjugated polyene, and the ethylene.α-olefin.nonconjugated polyene random copolymer is a rubber. The α-olefin is the same as the case of the above ethylene.α-olefin random copolymer.

The nonconjugated polyenes include nonconjugated noncyclic dienes such as 5-ethylidene-2-norbornene, 5-propylidene-5-norbornene, dicyclopentadiene, 5-vinyl-2-norbornene, 5-methylene-2-norbornene, 5-isopropylidene-2-norbornene, and norbornadiene;

chained nonconjugated dienes such as 1,4-hexadiene, 4-methyl-1,4-hexadiene, 5-methyl-1,4-hexadiene, 5-methyl-1,5-heptadiene, 6-methyl-1,5-heptadiene, 6-methyl-1,7-octadiene, and 7-methyl-1,6-octadiene; and

trienes such as 2,3-diisopropylidene-5-norbornene. Among the nonconjugated dienes, 1,4-hexadiene, dicyclopentadiene, and 5-ethylidene-2-norbornene are preferably used.

In the case that the nonconjugated polyene is the above compound, the molded product which is excellent in impact resistance and mechanical strength can be obtained.

The ethylene.α-olefin.nonconjugated polyene random copolymer is generally a copolymer of ethylene in the range of 90 to 30% by mole, and α-olefin in the range of 5 to 45% by mole, and nonconjugated polyene in the range of 5 to 25% by mole.

MI (JIS K7210: 190° C., test lode of 21.18N) is preferably in the range of 0.05 g/10 min. to 100 g/10 min., and more preferably in the range of 0.1 to 10 g/10 min. With the MI in the above range, a molded product which is excellent in the balance between molding processability and mechanical strength can be obtained.

As the ethylene.α-olefin.nonconjugated polyene random copolymer, ethylene.propylene.diene ternary copolymer (EPDM), and the like may be exemplified.

The weight ratio of the polypropylene and the olefin thermoplastic elastomer which are used as a raw material of the polypropylene resin mixture (1) is generally 55 to 95% by weight of polypropylene and 5 to 45% by weight of an olefin thermoplastic resin elastomer, on the basis of 100% by weight of the total amount of the polypropylene and the olefin elastomer.

As for the weight ratio, the content of the propylene and the olefin elastomer is preferably 60 to 90% by weight, and 10 to 40% by weight, respectively, and the content of the propylene and the olefin elastomer is more preferably 70 to 90% by weight, and 10 to 30% by weight, respectively, on the basis of 100% by weight of the total amount of the polypropylene and the olefin elastomer.

With the content ratio of the polypropylene and the olefin elastomer in the above range, a molded product which has excellent balance between molding processability and mechanical strength can be obtained.

[Polyolefin Wax (B)]

The polyolefin wax (B) used in the present invention is an olefin oligomer which is a homopolymer or copolymer of α-olefins, and can be prepared using a Ziegler catalyst or a metallocene catalyst. Among these, a polyethylene wax such as a homopolymer of ethylene or a copolymer of ethylene and an α-olefin having 3 to 20 carbon atoms is preferable, and a polyethylene wax (B) (hereinafter, simply referred to as a “metallocene polyethylene wax”) prepared by using a metallocene catalyst is particularly preferable.

In the copolymer of ethylene and an α-olefin having 3 to 20 carbon atoms, the α-olefin preferably has 3 to 10 carbon atoms, and the α-olefin is more preferably propylene having 3 carbon atoms, 1-butene having 4 carbon atoms, 1-pentene having 5 carbon atoms, 1-hexene and 4-methyl-1-pentene having 6 carbon atoms, 1-octene having 8 carbon atoms, or the like, and particularly preferably propylene, 1-butene, 1-hexene, or 4-methyl-1-pentene.

The polyolefin wax (B) has a number-average molecular weight (Mn) in terms of polyethylene, as measured by gel permeation chromatography, in the range of usually 400 to 5,000, preferably 1,000 to 4,000, more preferably 1,500 to 4,000. With the Mn of the polyolefin wax in the above range, there are provided such the effects as increased improvement on the fluidity, longer flow length, thus making the precision molding easier, as well as exhibition of good releasing effect, thus excellent mold releasability and prevention of mold fouling.

Further, the ratio (Mw/Mn) of the weight-average molecular weight (Mw) to the number-average molecular weight (Mn) in terms of polyethylene, as measured by gel permeation chromatography, is in the range of usually 1.2 to 4.0, preferably 1.5 to 3.5, more preferably 1.5 to 3.0. With the Mw/Mn in the above range, mold releasability is excellent, and mold fouling can be prevented.

The melting point, as measured by differential scanning calorimetry (DSC), is in the range of usually 65 to 130° C., preferably 70 to 130° C., more preferably 75 to 130° C. With the melting point in the above range, mold releasability is excellent, and mold fouling can be prevented.

The density, as measured by a density gradient tube process, is in the range of usually 850 to 980 kg/m³, preferably 870 to 980 kg/m³, more preferably 890 to 980 kg/m³. With the density in the above range, mold releasability is excellent, and mold fouling can be prevented.

Further, the polyolefin wax preferably satisfies the following relationship represented by the following expression (III), preferably the following expression (IIIa), and more preferably the following expression (IIIb), of the crystallization temperature (Tc (° C.), measured at a temperature lowering rate of 2° C./min.), as measured by a differential scanning calorimetry (DSC), and the density (D (kg/m³)), as measured by a density gradient tube process:
0.501×D−366≧Tc (III)
0.501×D−366.5≧Tc (IIIa)
0.501×D−367≧Tc (IIIb)

When the crystallization temperature (Tc) and the density (D) of the polyolefin wax satisfies the above expression, the composition of the comonomers of the polyolefin wax is uniform, and as a result, the content of the tacky components is decreased, and thus the tackiness of the mixture or the composition comprising the thermoplastic resin and the polyolefin wax tends to be reduced.

It is preferable that the penetration hardness is usually 30 dmm or less, preferably 25 dmm or less, more preferably 20 dmm or less, even more preferably 15 dmm or less. The penetration hardness is a value measured in accordance with JIS K2207. With the penetration hardness in the above range, a molded article having sufficient rigidity can be obtained.

The acetone extraction quantity is in the range of preferably 0 to 20% by weight, more preferably 0 to 15% by weight. With the acetone extraction quantity in the above range, mold releasability is excellent, and mold fouling can be prevented. The acetone extraction quantity is a value measured in the following manner. 200 ml of acetone is introduced into a round-bottom flask (300 ml) in the lower part of a Soxhlet's extractor (made of glass) through a filter (ADVANCE, No. 84). Extraction is carried out in a hot-water bath at 70° C. for 5 hours. The amount of the wax set on the filter is 10 g.

The polyolefin wax is a solid at room temperature, and is a low-viscosity liquid at 65 to 130° C.

[Polyethylene Wax]

In the invention, among the polyolefin wax (B), polyethylene wax is preferable. The polyethylene wax is a homopolymer of ethylene or a copolymer of ethylene and a small amount of α-olefin, or the blended product thereof wherein the number-average molecular weight (Mn) in terms of polyethylene, as measured by gel permeation chromatography (GPC), is in the range of usually 500 to 4,000. The number-average molecular weight (Mn) in terms of polyethylene of the above polyethylene wax is measured by gel permeation chromatography (GPC) under the following condition.

(Number Average Molecular Weight (Mn))

The number-average molecular weight is measured by a GPC measurement. The measurement is performed under the following conditions. The number-average molecular weight is determined by firstly preparing a calibration curve by the use of the commercially available monodisperse standard polystyrene, and calculating by the following conversion method.

Appliance: Gel permeation chromatograph Alliance GPC2000 model (manufactured by Waters Co., Ltd.)

Solvent: o-dichlorobenzene

Column: TSKgel column (manufactured by TOSOH Corporation)×4

Flow rate: 1.0 ml/min.

Sample: 0.15 mg/mL of o-dichlorobenzene

Temperature: 140° C.

Molecular weight conversion: PE conversion/general calibration approach

For the calculation of general calibration approach, a coefficient of Mark-Houwink viscosity expression as shown below is used.

Coefficient of polystyrene (PS): KPS=1.38×10⁻⁴, aPS=0.70

Coefficient of polyethylene (PE): KPE=5.06×10⁻⁴, aPE=0.70

The preferable polyethylene wax in the invention has a density in the range of 880 to 980 (kg/m³). The density of the polyethylene wax is a value as measured by the density gradient tube process of JIS K7112.

The polyethylene wax of the invention preferably has a specific relation represented by following expression (I) between the molecular weight and melt viscosity:
B≦0.0075×K (I)

wherein B is a content ratio (% by weight) of the component having a molecular weight of 20,000 or more in terms of polyethylene in the polylethylene wax on the basis of the weight. K is a melt viscosity (mPa·s) at 140° C. of the polyethylene wax measured by the Brookfield (B type) viscometer.

When the polyethylene wax which satisfies the condition of the above expression (I) is used, the excellent dispersion exhibits to the thermoplastic resin (A). Specifically, when the thermoplastic resin (A) is polyolefin resin, the more excellent dispersion is exhibited.

In the case of using polyethylene (1), polyethylene (2), or polypropylene as the polyolefin resin, if such polyethylene wax is used, the fluidity is improved, as compared with the case of adding no polyethylene wax, an injection molded product having a same mechanical properties can be obtained even if the injection molding is performed at low molding temperature, and deterioration of the mechanical properties due to an addition of the wax is prevented. In addition, the injection molded product has excellent mold releasability, and mold fouling can be prevented. Further, the injection molding is possible at low molding temperature, the cooling time is reduced, and thus the molding cycle can be increased. Furthermore, the heat deterioration of the resin can be prevented by lowering molding temperature, the deterioration of the resin strength can be also prevented, as well as the burn and black dot of the resin can be prevented.

In the case of using the polypropylene resin mixture (1) as the polyolefin resin, the productivity can be improved without losing the moldability upon the injection molding, by the use of the polyethylene wax satisfying the condition of above expression (I), the molded product tends not to lose mechanical properties such as impact resistance and deflection temperature under load of which the polypropylene resin mixture comprising polypropylene and olefin elastomer originally has.

If the injection molding is performed by mixing conventional polyethylene wax having low melt viscosity with the thermoplastic resin such as polyolefin resin, the fluidity and the productivity upon the molding has tendency to be improved, due to a lowering of the viscosity of whole mixture, as compared with the case of adding no polyethylene wax. However, although the productivity is thus improved, the moldability may be lost, for example, the mold releasability may be lowered, the mechanical properties may be inadequate, or the heat distortion property such as the deflection temperature under load may be lost in some cases.

The present inventor has studied, and as a result, they found that the ratio of the component having the molecular weight of 20,000 or more in the polyethylene wax to be used is extremely important for the mechanical property of the molded product obtained in the injection molding in conjunction with the melt viscosity. The detailed mechanism is not obvious, but it is considered that during melt kneading polyethylene wax with thermoplastic resin, particularly polyolefin resin, the component having the molecular weight of 20,000 or more in the whole polyethylene wax has a specific fusion behavior in the whole wax, and thus the polyethylene wax is not well dispersed to the thermoplastic resin, particularly to the polyolefin resin, unless the component having the molecular weight of 20,000 or more is under the specified level, from the view point of the melt viscosity of whole polyethylene wax, thereby giving the influences for mechanical property, heat distortion property such as deflection temperature under load, and moldability such as mold releasability of the finally obtained molded product.

The polyethylene wax having the B value in the above range can be prepared by the use of a metallocene catalyst. Among the metallocene catalyst, a metallocene catalyst wherein the ligand is not bridged is preferable. Such metallocene catalyst may be exemplified by the metallocene compound represented by the following general formula (1).

Furthermore, the B value can be controlled by the polymerization temperature. For example, in the case of producing the polyethylene wax by the use of the metallocene catalyst to be described later, the polymerization temperature is usually in the range of 100 to 200° C., but preferably in the range of 100 to 180° C., and more preferably in the range of 100 to 170° C., from the view point of producing the polyethylene wax having the B value.

It is preferable that the polyethylene wax of the invention further has the specific relation between the molecular weight and the melt viscosity thereof represented by the expression (II):
A≦230×K^{(-0.537)} (II)

wherein A is the content ratio (% by weight) of the component having a molecular weight of 1,000 or less in terms of polyethylene in the polyethylene wax on the basis of the weight, as measured by gel permeation chromatography, and K is a melt viscosity (mPa·S) at 140° C. of the polyethylene wax.

In the case of using the polyethylene wax satisfying the condition of above expression (II), the property of which the thermoplastic resin has, tends not to be lost and the bleed out from the surface of the molded product tends to be decreased.

In the case of using polyethylene (1), polyethylene (2), or polypropylene as the polyolefin resin (A), the molded product obtained by using the polyethylene wax satisfying the condition of above expression (II) tends to have same mechanical property, as compared with the case of adding no polyethylene wax, and the bleed out from the surface of the molded product tends to be decreased. In addition, the injection molded product has excellent mold releasability, and mold fouling can be prevented. Further, the injection molding is possible at low molding temperature, the cooling time is reduced, and thus the molding cycle can be increased. Furthermore, the heat deterioration of the resin can be prevented by lowering molding temperature, the deterioration of the resin strength can be also prevented, as well as the burn and black dot of the resin can be prevented.

In the case of using the polypropylene resin mixture (1) as the polyolefin resin (A), the productivity can be improved without losing the moldability upon the injection molding, by the use of the polyethylene wax satisfying the condition of above expression (II), the molded product tends not to lose mechanical properties such as tensile property, bending property, impact resistance and heat distortion properties such as deflection temperature under load of which the polypropylene resin mixture comprising polypropylene and olefin elastomer originally has, and the bleed out from the surface of the molded product tends to be decreased.

As described above, if the injection molding is performed by mixing polyethylene wax having low melt viscosity with the thermoplastic resin such as polyolefin resin, the fluidity and the productivity upon the molding has tendency to be improved, due to a lowering of the viscosity of whole mixture, as compared with the case of adding no polyethylene wax. However, although the productivity is thus improved, the mold releasability of the molded product to be obtained may be lowered, or the mechanical property may be lost, and in some cases the bleed out from the surface of the molded product causes the problems.

The present inventor has studied, and as a result, they found that the ratio of the component has the molecular weight of 1,000 or less in the polyethylene wax to be used is extremely important for the mechanical property of the molded product obtained in the injection molding in conjunction with the melt viscosity. The detailed mechanism is not obvious, but it is considered that during melt kneading polyethylene wax with thermoplastic resin, particularly polyolefin resin, the component having the molecular weight of 1,000 or less in the whole polyethylene wax is easy to be melt and has a specific fusion behavior in the whole wax, and thus an exuding to the surface or deterioration may be caused in some situation, unless the component having the molecular weight of 1,000 or less is under the specified level, from the view point of the melt viscosity of whole polyethylene wax, thereby giving the influences for mechanical property of the molded product to be finally obtained, and bleed out.

The polyethylene wax having the A value in the above range can be prepared by the use of a metallocene catalyst. Among the metallocene catalyst, a metallocene catalyst wherein the ligand is not bridged is preferable. Such metallocene catalyst may be exemplified by the metallocene compound represented by general formula (1).

Furthermore, the A value can be controlled by the polymerization temperature. For example, in the case of producing the polyethylene wax by the use of the metallocene catalyst to be described later, the polymerization temperature is usually in the range of 100 to 200° C., but preferably in the range of 100 to 180° C., and more preferably in the range of 100 to 170° C., from the view point of producing the polyethylene wax having the A value.

The number average molecular weight (Mn) of the polyethylene wax is in the range of 500 to 4,000.

In the case of using the polyethylene (1) as the thermoplastic resin (A), the number average molecular weight (Mn) of the polyethylene wax is preferably 1,000 to 3,800, and particularly preferably 2,000 to 3,500. With the number molecular weight (Mn) of the polyethylene wax in the above range, the dispersion of the polyethylene wax to the polyethylene (1) tends to be better.

In the case of using the polyethylene (2) as the thermoplastic resin (A), the number average molecular weight (Mn) of the polyethylene wax is preferably 500 to 3,000, more preferably 800 to 2,800, and particularly preferably 1,000 to 2,500. With the number molecular weight (Mn) of the polyethylene wax in the above range, the dispersion of the polyethylene wax to the polyethylene tends to be better.

In the case of using the polypropylene as the thermoplastic resin (A), the number average molecular weight (Mn) of the polyethylene wax is preferably 1,000 to 3,800, and particularly preferably 1,500 to 3,500. With the number molecular weight (Mn) of the polyethylene wax in the above range, the dispersion of the polyethylene wax to the polypropylene, tends to be better.

The Mn of the polyethylene wax can be controlled by the polymerization temperature. For example, in the case of producing the polyethylene wax by the use of the metallocene catalyst to be described later, the polymerization temperature is usually in the range of 100 to 200° C., but preferably in the range of 100 to 180° C., and more preferably in the range of 100 to 170° C., from the view point of producing the polyethylene wax having the Mn in the above preferable range.

The density of the polyethylene wax (D(kg/m³)) is in the range of 880 to 980 (kg/m³).

In the case of using polyethylene (1) as the thermoplastic resin (A), the density of the polyethylene wax is preferably in the range of 890 to 980 (kg/m³), more preferably in the range of 895 to 960 (kg/m³), and even more preferably in the range of 900 to 940 (kg/m³). With the density (D) of the polyethylene wax in the above range, the dispersion of the polyethylene wax to the polyethylene (1) tends to be better.

In the case of using polyethylene (2) as the thermoplastic resin (A), the density of the polyethylene wax is preferably in the range of 890 to 980 (kg/m³), more preferably in the range of 920 to 980 (kg/m³), and even more preferably in the range of 950 to 980 (kg/m³). With the density (D) of the polyethylene wax in the above range, the dispersion of the polyethylene wax to the polyethylene (2) tends to be better.

In the case of using polypropylene as the thermoplastic resin (A), the density of the polyethylene wax is preferably in the range of 890 to 980 (kg/m³), more preferably in the range of 895 to 960 (kg/m³), and even more preferably in the range of 900 to 940 (kg/m³). With the density (D) of the polyethylene wax in the above range, the dispersion of the polyethylene wax to the polypropylene tends to be better.

In the case of using polypropylene resin mixture (1) as the thermoplastic resin (A), the density of the polyethylene wax is preferably in the range of 880 to 920 (kg/m³). With the density (D) of the polyethylene wax in the above range, and if the B value or both the A value and the B value is satisfied, there is tendency to maintain mechanical properties such as tensile property, bending property, and heat distortion properties such as deflection temperature under load and to maintain or improve impact resistance, as compared with polypropylene resin mixture containing no wax.

The density of the polyethylene wax depends on the number average molecular weight (Mn) of polyethylene wax, when the polyethylene wax is a homopolymer of ethylene. For example, the density of the polymer to be obtained can be controlled to be lowered, by lowering the molecular weight of the polyethylene wax. When the polyethylene wax is the copolymer of ethylene and α-olefin, the density of the polyethylene wax depend on the number average molecular weight (Mn), and can be controlled by the amount and the kind of α-olefin to ethylene upon the polymerization. For example, the density of the polymer to be obtained can be decreased by increasing the used amount of α-olefin to ethylene.

From the view point of the density of polyethylene wax, an ethylene homopolymer, a copolymer of ethylene and α-olefin having 3 to 20 carbon atoms, or the mixture thereof is preferable.

As the example of the α-olefin used in the preparation of the copolymer of ethylene and α-olefin having 3 to 20 carbon atoms, α-olefin having 3 to 10 carbon atoms is preferable, propylene, 1-butene, 1-pentene, 1-hexene, 4-methyl-1-pentene, and 1-octnene are more preferable, and propylene, 1-butene, 1-hexene, and 4-methyl-1-pentene are particularly preferable.

It is preferable that the α-olefin used in the preparation of the copolymer of ethylene is in the range of 0 to 20% by mol based on the whole monomer.

Furthermore, the density of the polyethylene wax can be controlled by the polymerization temperature. For example, in the case of producing the polyethylene wax by the use of the metallocene catalyst to be described later, the polymerization temperature is usually in the range of 100 to 200° C., but preferably in the range of 100 to 180° C., and more preferably in the range of 100 to 170° C., from the view point of producing the polyethylene wax having the density in the above preferable range.

Such polyethylene wax is a solid at room temperature, and is a liquid having low viscosity at the temperature of 65 to 130° C.

Further, the polyolefin wax preferably satisfies the following relationship between the crystallization temperature (Tc(° C.)), as measured by a differential scanning calorimetry (DSC), and the density (D (kg/m³)), as measured by a density gradient tube process, of preferably following expression (IV), more preferably following expression (IVa), and even more preferably following expression (IVb):
0.501×D−366≧Tc (IV)
0.501×D−366.5≧Tc (IVa)
0.501×D−367≧Tc (IVb)

When the crystallization temperature (Tc) and the density (D) of the polyolefin wax satisfy the above expression, the dispersion of the polyethylene wax to the polyethylene tends to be better.

The polyethylene wax satisfying the relationship of the above expressions can be prepared by the use of a metallocene catalyst. Among the metallocene catalyst, a metallocene catalyst wherein the ligand is not bridged is preferable. Such metallocene catalyst may be exemplified by the metallocene compound represented by general formula (1).

Furthermore, the polyethylene wax satisfying the relationship of the above expressions can be produced by controlling the polymerization temperature. For example, in the case of producing the polyethylene wax by the use of the metallocene catalyst to be described later, the polymerization temperature is usually in the range of 100 to 200° C., but preferably in the range of 100 to 180° C., and more preferably in the range of 100 to 170° C., from the view point of producing the polyethylene wax having the B value.

As the preferable metallocene catalyst for preparing the polyolefin wax such as polyethylene wax, may be exemplified by the olefin polymerization catalyst comprising for example:

(A) a metallocene compound of a transition metal selected from Group 4 of the periodic table, and

(B) at least one kind of the compound selected from (b-1) an organoaluminum oxy-compound, (b-2) a compound which reacts with the metallocene compound (A) to form ion pairs, and (b-3) an organoaluminum compound.

These compounds will be explained in detail below.

<Metallocene Compound>

(A) Metallocene Compound of Transition Metal Selected from Group 4 of Periodic Table:

The metallocene compound for forming the metallocene catalyst is a metallocene compound of a transition metal selected from Group 4 of the periodic table, and a specific example thereof is a compound represented by the following formula (1):
M¹Lₓ (1)

In the above formula, M¹ is a transition metal selected from Group 4 of the periodic table, x is a valence of the transition metal M¹, and L is a ligand. Examples of the transition metals indicated by M¹ include zirconium, titanium and hafnium. L is a ligand coordinated to the transition metal M¹, and at least one ligand L is a ligand having cyclopentadienyl skeleton. This ligand having cyclopentadienyl skeleton may have a substituent. Examples of the ligands L having cyclopentadienyl skeleton include a cyclopentadienyl group, alkyl or cycloalkyl substituted cyclopentadienyl groups, such as methylcyclopentadienyl, ethylcyclopentadienyl, n- or i-propylcyclopentadienyl, n-, i-, sec-, or t-butylcyclopentadienyl, dimethylcyclopentadienyl, methylpropylcyclopentadienyl, methylbutylcyclopentadienyl and methylbenzylcyclopentadienyl, an indenyl group, a 4,5,6,7-tetrahydroindenyl group and a fluorenyl group. In these ligands having cyclopentadienyl skeleton, hydrogen may be replaced with a halogen atom, a trialkylsilyl group or the like.

When the metallocene compound has two or more ligands having cyclopentadienyl skeleton as ligands L, two of the ligands having cyclopentadienyl skeleton may be bonded to each other through an alkylene group, such as ethylene or propylene, a substituted alkylene group, such as isopropylidene or diphenylmethylene, a silylene group, or a substituted silylene group, such as dimethylsilylene, diphenylsilylene or methylphenylsilylene.

The ligand L other than the ligand having cyclopentadienyl skeleton (ligand having no cyclopentadienyl skeleton) is, for example, a hydrocarbon group of 1 to 12 carbon atoms, an alkoxy group, an aryloxy group, a sulfonic acid-containing group (—SO₃R¹), wherein R¹ is an alkyl group, an alkyl group substituted with a halogen atom, an aryl group, an aryl group substituted with a halogen atom, or an aryl group substituted with an alkyl group, a halogen atom or a hydrogen atom.

### Example 1 of Metallocene Compound

When the metallocene compound represented by the above formula (1) has a transition metal valence of, for example, 4, this metallocene compound is more specifically represented by the following formula (2):
R²ₖR³ₗR⁴ₘR⁵ₙM¹ (2)

wherein M¹ is a transition metal selected from Group 4 of the periodic table, R² is a group (ligand) having cyclopentadienyl skeleton, and R³, R⁴ and R⁵ are each independently a group (ligand) having or not having cyclopentadienyl skeleton, k is an integer of 1 or greater, and k+l+m+n=4.

Examples of the metallocene compounds having zirconium as M¹ and having at least two ligands having cyclopentadienyl skeleton include bis(cyclopentadienyl)zirconium monochloride monohydride, bis(cyclopentadienyl)zirconium dichloride, bis(1-methyl-3-butylcyclopentadienyl)zirconium-bis(trifluoromethanesulfonate) and bis(1,3-dimethylcyclopentadienyl)zirconium dichloride.

Also employable are compounds wherein the 1,3-position substituted cyclopentadienyl group in the above compounds is replaced with a 1,2-position substituted cyclopentadienyl group.

As another example of the metallocene compound, a metallocene compound of bridge type wherein at least two of R², R³, R⁴ and R⁵ in the formula (2), e.g., R² and R³, are groups (ligands) having cyclopentadienyl skeleton and these at least two groups are bonded to each other through an alkylene group, a substituted alkylene group, a silylene group, a substituted silylene group or the like is also employable. In this case, R⁴ and R⁵ are each independently the same as the aforesaid ligand L other than the ligand having cyclopentadienyl skeleton.

Examples of the metallocene compounds of bridge type include ethylenebis(indenyl)dimethylzirconium, ethylenebis(indenyl)zirconium dichloride, isopropylidene(cyclopentadienyl-fluorenyl)zirconium dichloride, diphenylsilylenebis(indenyl)zirconium dichloride and methylphenylsilylenebis(indenyl)zirconium dichloride.

### Example 2 of Metallocene Compound

Another example of the metallocene compound is a metallocene compound represented by the following formula (3) that is described in JP-A No. Hei 4-268307.

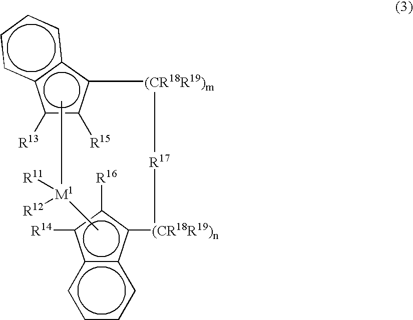

In the above formula, M¹ is a transition metal of Group 4 of the periodic table, specifically titanium, zirconium or hafnium.

R¹¹ and R¹² may be the same as or different from each other and are each a hydrogen atom, an alkyl group of 1 to 10 carbon atoms, an alkoxy group of 1 to 10 carbon atoms, an aryl group of 6 to 10 carbon atoms, an aryloxy group of 6 to 10 carbon atoms, an alkenyl group of 2 to 10 carbon atoms, an arylalkyl group of 7 to 40 carbon atoms, an alkylaryl group of 7 to 40 carbon atoms, an arylalkenyl group of 8 to 40 carbon atoms or a halogen atom. R¹¹ and R¹² are each preferably a chlorine atom.

R¹³ and R¹⁴ may be the same as or different from each other and are each a hydrogen atom, a halogen atom, an alkyl group of 1 to 10 carbon atoms which may be halogenated, an aryl group of 6 to 10 carbon atoms, or a group of —N(R²⁰)₂, —SR²⁰, —OSi(R²⁰)₃, —Si(R²⁰)₃ or —P(R²⁰)₂. R²⁰ is a halogen atom, preferably a chlorine atom, an alkyl group of 1 to 10 carbon atoms (preferably 1 to 3 carbon atoms) or an aryl group of 6 to 10 carbon atoms (preferably 6 to 8 carbon atoms). R¹³ and R¹⁴ are each particularly preferably a hydrogen atom.

R¹⁵ and R¹⁶ are the same as R¹³ and R¹⁴, except that a hydrogen atom is not included, and they may be the same as or different from each other, preferably the same as each other. R¹⁵ and R¹⁶ are each preferably an alkyl group of 1 to 4 carbon atoms which may be halogenated, specifically methyl, ethyl, propyl, isopropyl, butyl, isobutyl, trifluoromethyl or the like, particularly preferably methyl. In the formula (3), R¹⁷ is selected from the following group. 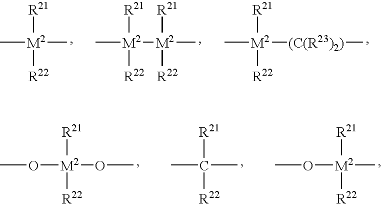
═BR²¹, ═AlR²¹, —Ge—, —Sn—, —O—, —S—, ═SO, ═SO₂, ═NR²¹, ═CO, ═PR²¹, ═P(O)R²¹, etc. M² is silicon, germanium or tin, preferably silicon or germanium. R²¹, R²² and R²³ may be the same as or different from one another and are each a hydrogen atom, a halogen atom, an alkyl group of 1 to 10 carbon atoms, a fluoroalkyl group of 1 to 10 carbon atoms, an aryl group of 6 to 10 carbon atom, a fluoroaryl group of 6 to 10 carbon atoms, an alkoxy group of 1 to 10 carbon atoms, an alkenyl group of 2 to 10 carbon atoms, an arylalkyl group of 7 to 40 carbon atoms, an arylalkenyl group of 8 to 40 carbon atoms, or an alkylaryl group of 7 to 40 carbon atoms. R²¹ and R²² or R²¹ and R²³ may form a ring together with atoms to which they are bonded. R¹⁷ is preferably ═CR²¹R²², ═SiR²¹R²², ═GeR²¹R²², —O—, —S—, ═SO, ═PR²¹ or ═P(O)R²¹. R¹⁸ and R¹⁹ may be the same as or different from each other and are each the same atom or group as that of R²¹. m and n may be same or different from each other and are each 0, 1 or 2, preferably 0 or 1, and m+n is 0, 1 or 2, preferably 0 or 1.

Examples of the metallocene compounds represented by the formula (3) include rac-ethylene(2-methyl-1-indenyl)₂-zirconium dichloride and rac-dimethylsilylene (2-methyl-1-indenyl)₂-zirconium dichloride. These metallocene compounds can be prepared by, for example, a process described in JP-A No. Hei 4-268307.

### Example 3 of Metallocene Compound

As the metallocene compound, a metallocene compound represented by the following formula (4) is also employable.

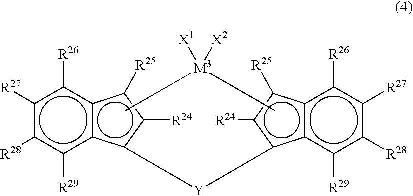

In the formula (4), M³ is a transition metal atom of Group 4 of the periodic table, specifically titanium, zirconium or hafnium. R²⁴ and R²⁵ may be the same as or different from each other and are each a hydrogen atom, a halogen atom, a hydrocarbon group of 1 to 20 carbon atoms, a halogenated hydrocarbon group of 1 to 20 carbon atoms, a silicon-containing group, an oxygen-containing group, a sulfur-containing group, a nitrogen-containing group or a phosphorus-containing group. R²⁴ is preferably a hydrocarbon group, particularly preferably an alkyl group of 1 to 3 carbon atoms, i.e., methyl, ethyl or propyl. R²⁵ is preferably a hydrogen atom or hydrocarbon group, particularly preferably a hydrogen atom or an alkyl group of 1 to 3 carbon atoms, i.e., methyl, ethyl or propyl. R²⁶, R²⁷, R²⁸ and R²⁹ may be the same as or different from one another and are each a hydrogen atom, a halogen atom, a hydrocarbon group of 1 to 20 carbon atoms or a halogenated hydrocarbon group of 1 to 20 carbon atoms. Of these, preferable is a hydrogen atom, a hydrocarbon group or a halogenated hydrocarbon group. At least one combination of “R²⁶ and R²⁷”, “R²⁷ and R²⁸”, and “R²⁸ and R²⁹” may form a monocyclic aromatic ring together with carbon atoms to which they are bonded. When there are two or more hydrocarbon groups or halogenated hydrocarbon groups other than the groups that form the aromatic ring, they may be bonded to each other to form a ring. When R²⁹ is a substituent other than the aromatic group, it is preferably a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁰—, —P(R³⁰)—, —P(O)(R³⁰)—, —BR³⁰— or —AlR³⁰— (R³⁰ is a hydrogen atom, a halogen atom, a hydrocarbon group of 1 to 20 carbon atoms or a halogenated hydrocarbon group of 1 to 20 carbon atoms).

Examples of the ligands in the formula (4) which have a monocyclic aromatic ring formed by mutual bonding of at least one combination of “R²⁶ and R²⁷”, “R²⁷ and R²⁸”, and “R²⁸ and R²⁹” and which are coordinated to M³ include those represented by the following formulas:

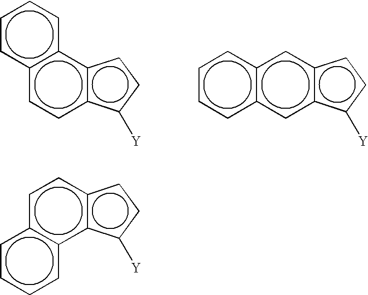

(wherein Y is the same as that described in the above-mentioned formula).

### Example 4 of Metallocene Compound

As the metallocene compound, a metallocene compound represented by the following formula (5) is also employable.

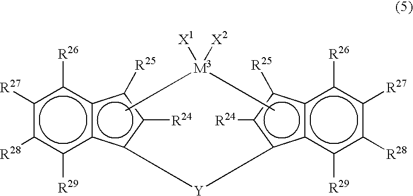

In the formula (5), M³, R²⁴, R²⁵, R²⁶, R²⁷, R²⁸ and R²⁹ are the same as those in the formula (4). Of R²⁶, R²⁷, R²⁸ and R²⁹, two groups including R²⁶ are each preferably an alkyl group, and R²⁶ and R²⁸, or R²⁸ and R²⁹ are each preferably an alkyl group. This alkyl group is preferably a secondary or tertiary alkyl group. Further, this alkyl group may be substituted with a halogen atom or a silicon-containing group. Examples of the halogen atoms and the silicon-containing groups include substituents exemplified with respect to R²⁴ and R²⁵. Of R²⁶, R²⁷, R²⁸ and R²⁹, groups other than the alkyl group are each preferably a hydrogen atom. Two groups selected from R²⁶, R²⁷, R²⁸ and R²⁹ may be bonded to each other to form a monocycle or a polycycle other than the aromatic ring. Examples of the halogen atoms include the same atoms as described with respect to R²⁴ and R²⁵. Examples of X¹, X² and Y include the same atoms and groups as previously described.

Examples of the metallocene compounds represented by the formula (5) include:

rac-dimethylsilylene-bis(4,7-dimethyl-1-indenyl)zirconium dichloride, rac-dimethylsilylene-bis(2,4,7-trimethyl-1-indenyl)zirconium dichloride and rac-dimethylsilylene-bis(2,4,6-trimethyl-1-indenyl)zirconium dichloride.

Also employable are transition metal compounds wherein the zirconium metal is replaced with a titanium metal or a hafnium metal in the above compounds. The transition metal compound is usually used as a racemic modification, but R form or S form is also employable.

### Example 5 of Metallocene Compound

As the metallocene compound, a metallocene compound represented by the following formula (6) is also employable.

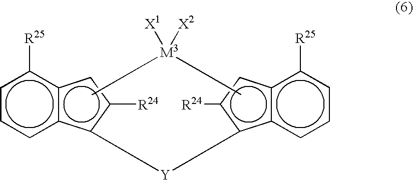

In the formula (6), M³, R²⁴, X¹, X² and Y are the same as those in the formula (4). R²⁴ is preferably a hydrocarbon group, particularly preferably an alkyl group of 1 to 4 carbon atoms, i.e., methyl, ethyl, propyl or butyl. R²⁵ is an aryl group of 6 to 16 carbon atoms. R²⁵ is preferably phenyl or naphthyl. The aryl group may be substituted with a halogen atom, a hydrocarbon group of 1 to 20 carbon atoms or a halogenated hydrocarbon group of 1 to 20 carbon atom. X¹ and X² are each preferably a halogen atom or a hydrocarbon group of 1 to 20 carbon atoms.

Examples of the metallocene compounds represented by the formula (6) include:

rac-dimethylsilylene-bis(4-phenyl-1-indenyl)zirconium dichloride, rac-dimethylsilylene-bis(2-methyl-4-phenyl-1-indenyl)zirconium dichloride, rac-dimethylsilylene-bis(2-methyl-4-(α-naphthyl)-1-indenyl)zirconium dichloride, rac-dimethylsilylene-bis(2-methyl-4-(β-naphthyl)-1-indenyl)zirconium dichloride and rac-dimethylsilylene-bis (2-methyl-4-(1-anthryl)-1-indenyl)zirconium dichloride. Also employable are transition metal compounds wherein the zirconium metal is replaced with a titanium metal or a hafnium metal in the above compounds.

### Example 6 of Metallocene Compound

As the metallocene compound, a metallocene compound represented by the following formula (7) is also employable.
LaM⁴X³₂ (7)

In the above formula, M⁴ is a metal of Group 4 or lanthanide series of the periodic table. La is a derivative of a delocalized n bond group and is a group imparting a constraint geometric shape to the metal M⁴ active site. Each X³ may be the same or different and is a hydrogen atom, a halogen atom, a hydrocarbon group of 20 or less carbon atoms, a silyl group having 20 or less silicon atoms or a germyl group having 20 or less germanium atoms.

Of such compounds, a compound represented by the following formula (8) is preferable.

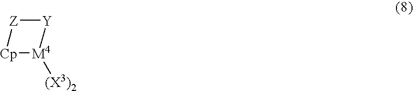

In the formula (8), M⁴ is titanium, zirconium or hafnium. X³ is the same as that described in the formula (7). Cp is π-bonded to M⁴ and is a substituted cyclopentadienyl group having a substituent Z. Z is oxygen, sulfur, boron or an element of Group 4 of the periodic table (e.g., silicon, germanium or tin). Y is a ligand having nitrogen, phosphorus, oxygen or sulfur, and Z and Y may together form a condensed ring. Examples of the metallocene compounds represented by the formula (8) include:

(dimethyl(t-butylamide)(tetramethyl-η⁵-cyclopentadienyl)silane)titanium dichloride and ((t-butylamide)(tetramethyl-η⁵-cyclopentadienyl)-1,2-ethanediyl)titanium dichloride. Also employable are metallocene compounds wherein titanium is replaced with zirconium or hafnium in the above compounds.

### Example 7 of Metallocene Compound

As the metallocene compound, a metallocene compound represented by the following formula (9) is also employable.

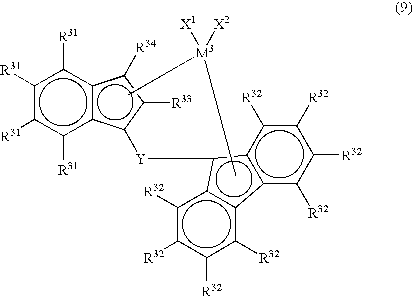

In the formula (9), M³ is a transition metal atom of Group 4 of the periodic table, specifically titanium, zirconium or hafnium, preferably zirconium. Each R³¹ may be the same or different, and at least one of them is an aryl group of 11 to 20 carbon atoms, an arylalkyl group of 12 to 40 carbon atoms, an arylalkenyl group of 13 to 40 carbon atoms, an alkylaryl group of 12 to 40 carbon atoms or a silicon-containing group, or at least two neighboring groups of the groups indicated by R³¹ form single or plural aromatic rings or aliphatic rings together with carbon atoms to which they are bonded. In this case, the ring formed by R³¹ has 4 to 20 carbon atoms in all including carbon atoms to which R³¹ is bonded. R³¹ other than R³¹ that is an aryl group, an arylalkyl group, an arylalkenyl group or an alkylaryl group or that forms an aromatic ring or an aliphatic ring is a hydrogen atom, a halogen atom, an alkyl group of 1 to 10 carbon atoms or a silicon-containing group. Each R³² may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. At least two neighboring groups of the groups indicated by R³² may form single or plural aromatic rings or aliphatic rings together with carbon atoms to which they are bonded. In this case, the ring formed by R³² has 4 to 20 carbon atoms in all including carbon atoms to which R³² is bonded. R³² other than R³² that forms an aromatic ring or an aliphatic ring is a hydrogen atom, a halogen atom, an alkyl group of 1 to 10 carbon atoms or a silicon-containing group. In the groups constituted of single or plural aromatic rings or aliphatic rings formed by two groups indicated by R³², an embodiment wherein the fluorenyl group part has such a structure as represented by the following formula is included.

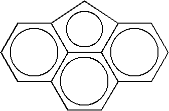

R³² is preferably a hydrogen atom or an alkyl group, particularly preferably a hydrogen atom or a hydrocarbon group of 1 to 3 carbon atoms, i.e., methyl, ethyl or propyl. A preferred example of the fluorenyl group having R³² as such a substituent is a 2,7-dialkyl-fluorenyl group, and in this case, an alkyl group of the 2,7-dialkyl is, for example, an alkyl group of 1 to 5 carbon atoms. R³ and R³² may be the same as or different from each other. R³³ and R³⁴ may be the same as or different from each other and are each a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, and arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group, similarly to the above. At least one of R³³ and R³⁴ is preferably an alkyl group of 1 to 3 carbon atoms. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X² form a conjugated diene residue. Preferred examples of the conjugated diene residues formed from X¹ and X² include residues of 1,3-butadiene, 2,4-hexadiene, 1-phenyl-1,3-pentadiene and 1,4-diphenylbutadiene, and these residues may be further substituted with a hydrocarbon group of 1 to 10 carbon atoms. X¹ and X² are each preferably a halogen atom, a hydrocarbon group of 1 to 20 carbon atoms or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁵—, —P(R³⁵)—, —P(O)(R³⁵)—, —BR³⁵— or —AlR³⁵— (R³⁵ is a hydrogen atom, a halogen atom, a hydrocarbon group of 1 to 20 carbon atoms or a halogenated hydrocarbon group of 1 to 20 carbon atoms). Of these divalent groups, preferable are those wherein the shortest linkage part of —Y— is constituted of one or two atoms. R³⁵ is a halogen atom, a hydrocarbon group of 1 to 20 carbon atoms or a halogenated hydrocarbon group of 1 to 20 carbon atoms. Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

### Example 8 of Metallocene Compound

As the metallocene compound, a metallocene compound represented by the following formula (10) is also employable.

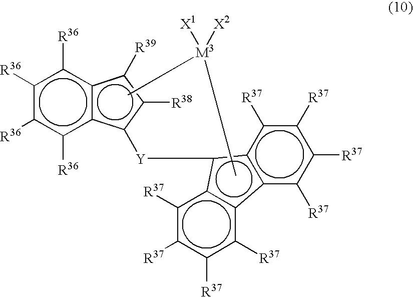

In the formula (10), M³ is a transition metal atom of Group 4 of the periodic table, specifically titanium, zirconium or hafnium, preferably zirconium. Each R³⁶ may be the same or different and is a hydrogen atom, a halogen atom, an alkyl group of 1 to 10 carbon atoms, an aryl group of 6 to 10 carbon atoms, an alkenyl group of 2 to 10 carbon atoms, a silicon-containing group, an oxygen-containing group, a sulfur-containing group, a nitrogen-containing group or a phosphorus-containing group. The alkyl group and the alkenyl group may be substituted with a halogen atom. R³⁶ is preferably an alkyl group, an aryl group or a hydrogen atom, particularly preferably a hydrocarbon group of 1 to 3 carbon atoms, i.e., methyl, ethyl, n-propyl or i-propyl, an aryl group, such as phenyl, α-naphthyl or β-naphthyl, or a hydrogen atom. Each R³⁷ may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. The alkyl group, the aryl group, the alkenyl group, the arylalkyl group, the arylalkenyl group and the alkylaryl group may be substituted with halogen. R³⁷ is preferably a hydrogen atom or an alkyl group, particularly preferably a hydrogen atom or a hydrocarbon group of 1 to 4 carbon atoms, i.e., methyl, ethyl, n-propyl, i-propyl, n-butyl or tert-butyl. R³⁶ and R³⁷ may be the same as or different from each other. One of R³⁸ and R³⁹ is an alkyl group of 1 to 5 carbon atoms, and the other is a hydrogen atom, a halogen atom, an alkyl group of 1 to 10 carbon atoms, an alkenyl group of 2 to 10 carbon atoms, a silicon-containing group, an oxygen-containing group, a sulfur-containing group, a nitrogen-containing group or a phosphorus-containing group. It is preferable that one of R³⁸ and R³⁹ is an alkyl group of 1 to 3 carbon atoms, such as methyl, ethyl or propyl, and the other is a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X² form a conjugated diene residue. X¹ and X² are each preferably a halogen atom or a hydrocarbon group of 1 to 20 carbon atoms. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR⁴⁰—, —P(R⁴⁰)—, —P(O) (R⁴⁰)—, —BR⁴⁰— or —AlR⁴⁰— (R⁴⁰ is a hydrogen atom, a halogen atom, a hydrocarbon group of 1 to 20 carbon atoms or a halogenated hydrocarbon group of 1 to 20 carbon atoms). Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

### Example 9 of Metallocene Compound

As the metallocene compound, a metallocene compound represented by the following formula (11) is also employable.

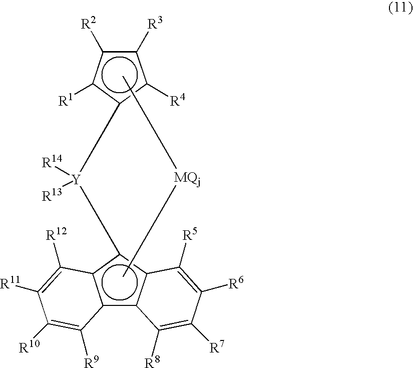

In the formula (11), Y is selected from carbon, silicon, germanium and tin atoms, M is Ti, Zr or Hf, R¹, R², R³, R⁴, R⁵, R⁶, R⁷, R⁸, R⁹, R¹⁰, R¹¹ and R¹² may be the same as or different from each other, and selected from hydrogen, a hydrocarbon group, and a silicon containing group, the adjacent substituents of R⁵ to R¹² may be bonded to each other to form a ring, R¹³ and R¹⁴ may be the same as or different from each other, and selected from a hydrocarbon group, and a silicon containing group, and R¹³ and R¹⁴ may be bonded to each other to form a ring. Q may be selected in the same or different combination from halogen, a hydrocarbon group, an anionic ligand, and a neutral ligand which can be coordinated to a lone pair of electrons, and j is an integer of 1 to 4.

Hereinbelow, the cyclopentadienyl group, the fluorenyl group, and the bridged part which are the characteristics in the chemical structure of the metallocene compound used in the present invention, and other characteristics are sequentially explained, and then preferred metallocene compounds having both these characteristics are also explained.

Cyclopentadienyl Group

The cyclopentadienyl group may be substituted or unsubstituted. The phrase “substituted or unsubstituted cyclopentadienyl group” means a cyclopentadienyl group in which R¹, R², R³, and R⁴ of the cyclopentadienyl skeleton in the formula (11) are all hydrogen atoms, or at least one of R¹, R², R³, and R⁴ is a hydrocarbon group (f1), preferably a hydrocarbon group (f1′) having a total of 1 to 20 carbon atoms, or a silicon-containing group (f2), preferably a silicon-containing group (f2′) having a total of 1 to 20 carbon atoms. If at least two of R¹, R², R³, and R⁴ are substituted, the substituents may be the same as or different from each other. Further, the phrase “hydrocarbon group having a total of 1 to 20 carbon atoms” means an alkyl group, an alkenyl group, an alkynyl group, or an aryl group, which is composed of only carbon and hydrogen. It includes one in which both of any two adjacent hydrogen atoms are substituted to form an alicyclic or aromatic ring.

Examples of the hydrocarbon group (f1′) having a total of 1 to 20 carbon atoms includes, in addition to an alkyl group, an alkenyl group, an alkynyl group, or an aryl group, which is composed of only carbon and hydrogen, a heteroatom-containing hydrocarbon group which is a hydrocarbon group in which a part of the hydrogen atoms directly bonded to carbon atoms are substituted with a halogen atom, an oxygen-containing group, a nitrogen-containing group, or a silicon-containing group, and an alicyclic group in which any two hydrogen atoms which are adjacent to each other are substituted. Examples of the hydrocarbon group (f1′) include:

a linear hydrocarbon group such as a methyl group, an ethyl group, an n-propyl group, an allyl group, an n-butyl group, an n-pentyl group, an n-hexyl group, an n-heptyl group, an n-octyl group, an n-nonyl group, and an n-decanyl group;

a branched hydrocarbon group such as an isopropyl group, a t-butyl group, an amyl group, a 3-methylpentyl group, a 1,1-diethylpropyl group, a 1,1-dimethylbutyl group, a 1-methyl-1-propyl butyl group, a 1,1-propyl butyl group, a 1,1-dimethyl-2-methylpropyl group, and a 1-methyl-1-isopropyl-2-methylpropyl group;

a cycloalkane group such as a cyclopentyl group, a cyclohexyl group, a cycloheptyl group, a cyclooctyl group, a norbornyl group, and an adamanthyl group;

a cyclic, unsaturated hydrocarbon group and a nuclear alkyl-substituted product thereof such as a phenyl group, a naphthyl group, a biphenyl group, a phenanthryl group, and an anthracenyl group;

a saturated hydrocarbons group substituted with an aryl group such as benzyl group and a cumyl group;

a heteroatom-containing hydrocarbon group such as a methoxy group, an ethoxy group, a phenoxy group, an N-methylamino group, a trifluoromethyl group, a tribromomethyl group, a pentafluoroethyl group, and a pentafluorophenyl group.

The phrase “silicon-containing group (f2)” means a group in which ring carbons of the cyclopentadienyl group are directly covalently bonded, and specific examples thereof include an alkyl silyl group and an aryl silyl group. Examples of the silicon-containing group (f2′) having a total of 1 to 20 carbon atoms include a trimethylsilyl group, and a triphenylsilyl group.

Fluorenyl Group

The fluorenyl group may be substituted or unsubstituted. The phrase “substituted or unsubstituted fluorenyl group” means a fluorenyl group in which R⁵, R⁶, R⁷, R⁸, R⁹, R¹⁰, R¹¹, and R¹² of the fluorenyl skeleton in the formula (11) are all hydrogen atoms, or at least one of R⁵, R⁶, R⁷, R⁸, R⁹, R¹⁰, R¹¹, and R¹² is a hydrocarbon group (f1), preferably a hydrocarbon group (f1′) having a total of 1 to 20 carbon atoms, or a silicon-containing group (f2), preferably a silicon-containing group (f2′) having a total of 1 to 20 carbon atoms. If at least two of R⁵, R⁶, R⁷, R⁸, R⁹, R¹⁰, R¹¹, and R¹² are substituted, the substituents may be the same as or different from each other. R⁵, R⁶, R⁷, R⁸, R⁹, R¹⁰, R¹¹, and R¹² may be bonded to each other to form a ring. From a viewpoint of easy preparation of a catalyst, R⁶ and R¹¹, and R⁷ and R¹⁰ are preferably the same to each other.

A preferable example of the hydrocarbon group (f1) is a hydrocarbon group (f1′) having a total of 1 to 20 carbon atoms, and a preferable example of the silicon-containing group (f2) is a silicon-containing group (f2′) having a total of 1 to 20 carbon atoms.

Covalent Bond Bridging

The main chain of the bond which binds the cyclopentadienyl group with the fluorenyl group is a divalent covalent bond bridging containing a carbon atom, a silicon atom, a germanium atom and a tin atom. An important point when carrying out a high temperature solution polymerization is that a bridging atom Y of the covalent bond bridging part has R¹³ and R¹⁴ which may be the same as or different from each other. A preferable example of the hydrocarbon group (f1) is a hydrocarbon group (f1′) having a total of 1 to 20 carbon atoms, and a preferable example of the silicon-containing group (f2) is a silicon-containing group (f2′) having a total of 1 to 20 carbon atoms.

Other Characteristics of Metallocene Compound

In the above-described formula (11), Q is selected in the same or different combination from halogen, a hydrocarbon group having 1 to 10 carbon atoms, a neutral, conjugated or non-conjugated diene having 10 carbon atoms or less, an anionic ligand, and a neutral ligand which can be coordinated to a lone pair of electrons. Specific examples of halogen include fluorine, chlorine, bromine, and iodine, and specific examples of the hydrocarbon group include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethylbutyl, neopentyl, cyclohexylmethyl, and cyclohexyl, 1-methyl-1-cyclohexyl. Specific examples of the neutral, conjugated or non-conjugated diene having 10 carbon atoms or less include s-cis- or s-trans-η⁴-1,3-butadiene, s-cis- or s-trans-η⁴-1,4-diphenyl-1,3-butadiene, s-cis- or s-trans-η⁴-3-methyl-1,3-pentadiene, s-cis- or s-trans-η⁴-1,4-dibenzyl-1,3-butadiene, s-cis- or s-trans-η⁴-2,4-hexadiene, s-cis- or s-trans-η4-1,3-pentadiene, s-cis- or s-trans-η⁴-1,4-ditolyl-1,3-butadiene, and s-cis- or s-trans-η⁴-1,4-bis(trimethylsilyl)-1,3-butadiene. Specific examples of the anionic ligand include an alkoxy group such as methoxy, tert-butoxy, and phenoxy, a carboxylate group such as acetate, and benzoate, and a sulfonate group such as mesylate, and tosylate. Specific examples of the neutral ligand which can be coordinated to a lone pair of electrons include organophosphorus compounds such as trimethylphosphine, triethylphosphine, triphenylphosphine, and diphenylmethyl phosphine, or ethers such as tetrahydrofuran, diethyl ether, dioxane, and 1,2-dimethoxyethane. j is an integer of 1 to 4, and when j is no less than 2, Q's may be the same as or different from each other.

### Example 10 of Metallocene Compound

As the metallocene compound, a metallocene compound represented by the following formula (12) is also employable.

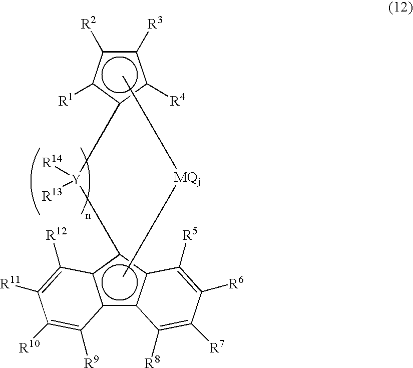

In the above formula, R¹, R², R³, R⁴, R⁵, R⁶, R⁷, R⁸, R⁹, R¹⁰, R¹¹, R¹², R¹³, and R¹⁴ may be the same as or different from each other, and selected from hydrogen, a hydrocarbon group, and a silicon containing group, the adjacent substituents of R¹ to R¹⁴ may be bonded to each other to form a ring, M is Ti, Zr or Hf, Y is an atom of Group 14 of the periodic table, Q is selected in the same or different combination from halogen, a hydrocarbon group, a neutral, conjugated or non-conjugated diene having 10 carbon atoms or less, an anionic ligand, and a neutral ligand which can be coordinated to a lone pair of electrons, n is an integer of 2 to 4, and j is an integer of 1 to 4.

In the formula (12), the hydrocarbon group is preferably an alkyl group having 1 to 20 carbon atoms, an arylalkyl group having 7 to 20 carbon atoms, an aryl group having 6 to 20 carbon atoms, or an alkylaryl group having 7 to 20 carbon atoms, and may contain at least one ring structure.

Specific examples thereof include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethyl butyl, neopentyl, cyclohexylmethyl, cyclohexyl, 1-methyl-1-cyclohexyl, 1-adamanthyl, 2-adamanthyl, 2-methyl-2-adamanthyl, menthyl, norbornyl, benzyl, 2-phenylethyl, 1-tetrahydro naphthyl, 1-methyl-1-tetrahydro naphthyl, phenyl, naphthyl, and tolyl.

In the formula (12), the silicon-containing group is preferably an alkyl or arylsilyl group having 1 to 4 silicon atoms and 3 to 20 carbon atoms, and specific examples thereof include trimethylsilyl, tert-butyldimethylsilyl, and triphenylsilyl.

In the present invention, R¹ to R¹⁴ in the formula (12) are selected from hydrogen, a hydrocarbon group, and a silicon-containing hydrocarbon group, and may be the same as or different from each other. Preferable examples of the hydrocarbon group and the silicon-containing group are as described above.

The adjacent substituents of R¹ to R¹⁴ in the cyclopentadienyl ring in the formula (12) may be bonded to each other to form a ring.

M of the formula (12) is an element of Group 4 of the periodic table, that is, zirconium, titanium or hafnium, preferably zirconium.

Y is an atom of Group 14 of the periodic table, preferably a carbon atom or a silicon atom. n is an integer of 2 to 4, preferably 2 to 3, and particularly preferably 2.

Q is selected in the same or different combination from halogen, a hydrocarbon group, a neutral, conjugated or non-conjugated diene having 10 carbon atoms or less, an anionic ligand, and a neutral ligand which can be coordinated to a lone pair of electrons. If Q is a hydrocarbon group, it is more preferably a hydrocarbon group having 1 to 10 carbon atoms.

Specific examples of halogen include fluorine, chlorine, bromine, and iodine, and specific examples of the hydrocarbon group include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethylbutyl, neopentyl, cyclohexylmethyl, and cyclohexyl, 1-methyl-1-cyclohexyl. Specific examples of the neutral, conjugated or non-conjugated diene having 10 carbon atoms or less include s-cis- or s-trans-η⁴-1,3-butadiene, s-cis- or s-trans-η⁴-1,4-diphenyl-1,3-butadiene, s-cis- or s-trans-η⁴-3-methyl-1,3-pentadiene, s-cis- or s-trans-η⁴-1,4-dibenzyl-1,3-butadiene, s-cis- or s-trans-η⁴-2,4-hexadiene, s-cis- or s-trans-η⁴-1,3-pentadiene, s-cis- or s-trans-η⁴-1,4-ditolyl-1,3-butadiene, and s-cis- or s-trans-η⁴-1,4-bis(trimethylsilyl)-1,3-butadiene. Specific examples of the anionic ligand include an alkoxy group such as methoxy, tert-butoxy, and phenoxy, a carboxylate group such as acetate, and benzoate, and a sulfonate group such as mesylate, and tosylate. Specific examples of the neutral ligand which can be coordinated to a lone pair of electrons include organophosphorus compounds such as trimethylphosphine, triethylphosphine, triphenylphosphine, and diphenylmethyl phosphine, or ethers such as tetrahydrofuran, diethyl ether, dioxane, and 1,2-dimethoxyethane. When j is no less than 2, Q's may be the same as or different from each other.

In the formula (12), 2 to 4 Y's are present, and Y's may be the same as or different from each other. A plurality of R¹³'s and a plurality of R¹⁴'s may be the same as or different from each other. For example, a plurality of R¹³'s which are bonded to the same Y may be different from each other, and a plurality of R¹³'s which are bonded to the different Y's may be the same to each other. Otherwise, R¹³'s and R¹⁴'s may be taken to form a ring.

Preferable examples of the compound represented by the formula (12) include a transition metal compound represented by the following formula (13).

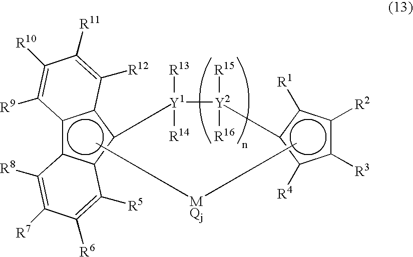

In the formula (13), R¹, R², R³, R⁴, R⁵, R⁶, R⁷, R⁸, R⁹, R¹⁰, R¹¹, and R¹² may be the same as or different from each other, and selected from hydrogen, a hydrocarbon group, and a silicon containing group, R¹³, R¹⁴, R¹⁵, and R¹⁶ are hydrogen, or a hydrocarbon group, and n is an integer of 1 to 3. With n=1, R¹ to R¹⁶ are not hydrogen at the same time, and each may be the same as or different from each other. The adjacent substituents of R⁵ to R¹² may be bonded to each other to form a ring, R¹³ and R¹⁵ may be bonded to each other to form a ring, and R¹³ and R¹⁵, and R¹⁴ and R¹⁶ may be bonded to each other to form a ring at the same time, Y¹ and Y² are atoms of Group 14 of the periodic table, M is Ti, Zr or Hf, Q is selected in the same or different combination from halogen, a hydrocarbon group, an anionic ligand, and a neutral ligand which can be coordinated to a lone pair of electrons, and j is an integer of 1 to 4.

The compounds such as those as described in “Example 9 of Metallocene Compound” and “Example 10 of Metallocene Compound” are mentioned in JP-A No. 2004-175707, WO2001/027124, WO2004/029062, and WO2004/083265.

The metallocene compounds described above are used singly or in combination of two or more kinds. The metallocene compounds may be used after diluted with hydrocarbon, halogenated hydrocarbon or the like.

The catalyst component is composed of (A) the metallocene compound represented as above, and (B) at least one kind of the compound selected from (b-1) the organoaluminum oxy-compound, (b-2) the compound which reacts with the metallocene compound (A) to form ion pairs, and (b-3) the organoaluminum compound.

The component (B) will be explained in detail below.

<(b-1) Organoaluminum Oxy-Compound>

According to the present invention, as the organoaluminum oxy-compound (b-1), publicly known aluminoxane can be used as it is. Specifically, such publicly known aluminoxane is represented by the following formula (s) (14) and/or (15):

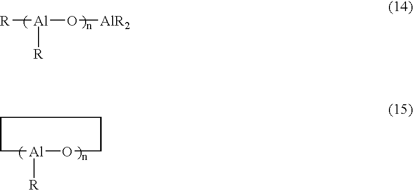

wherein R represents a hydrocarbon group having 1 to 10 carbon atoms, and n represents an integer of 2 or more. Among these compound, the methyl aluminoxanes in which R is a methyl group and n is 3 or more, preferably 10 or more are preferably used. These aluminoxanes may be incorporated with some organoaluminum compounds. In addition, when a high temperature solution polymerization is carried out, the benzene-insoluble organoaluminum oxy-compounds as described in JP-A No. Hei 2-78687 can be employed. Further, the organoaluminum oxy-compounds as described in JP-A No. Hei 2-167305, and the aluminoxanes having at least two kinds of alkyl groups as described in JP-A Nos. Hei 2-24701, and Hei 3-103407 are preferably used. In addition, the phrase “benzene insoluble” regarding the organoaluminum oxy-compounds, the proportion of the Al components dissolved in benzene at 60° C. in terms of an Al atom is usually 10% or less, preferably 5% or less, and particularly preferably 2% or less, and that is, the compound has insolubility or poor solubility in benzene.

Examples of the organoaluminum oxy-compound used in the present invention include a modified methyl aluminoxane having the structure of the following structure (16).

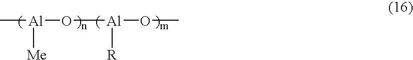

(wherein R represents a hydrocarbon group having 1 to 10 carbon atoms, and m and n represent integers of 2 or more).

This modified methyl aluminoxane is prepared from trimethyl aluminum and alkyl aluminum other than trimethyl aluminum. This compound [V] is generally referred to as MMAO. Such the MMAO can prepared by the method as described in U.S. Pat. Nos. 4,960,878 and 5,041,584. Further, the modified methyl aluminoxane in which R is an iso-butyl group, prepared from trimethyl aluminum and tri-isobutyl aluminum is commercially produced in a trade name of MMAO or TMAO from Tosoh Finechem Corp. The MMAO is aluminoxane with improved solubility in various solvents, and storage stability, and specifically, it is dissolved in an aliphatic or alicyclic hydrocarbon, although the aluminoxane described for the formula (14) or (15) has insolubility or poor solubility in benzene.

Further, examples of the organoaluminum oxy-compound used in the present invention include a boron-containing organoaluminum oxy-compound represented by the following formula (17):

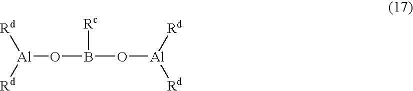

(wherein R^{c} represents a hydrocarbon group having 1 to 10 carbon atoms, R^{d}'s may be the same as or different from each other, and represent a hydrogen atom, a halogen atom or a hydrocarbon group having 1 to 10 carbon atoms).

<(b-2) Compounds which React with the Metallocene Compound (A) to Form an Ion Pair>

Examples of the compound (b-2) which reacts with the metallocene compound (A) to form an ion pair (referred to as an “ionic compound” hereinafter) may include Lewis acids, ionic compounds, borane compounds and carborane compounds, as described in each publication of JP-A Nos. Hei 1-501950, Hei 1-502036, Hei 3-179005, Hei 3-179006, Hei 3-207703 and Hei 3-207704, and U.S. Pat. No. 5,321,106. They also include a heteropoly compound and an iso-poly compound.

According to the present invention, the ionic compound which is preferably employed is a compound represented by the following formula (18):

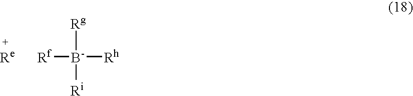

wherein examples of R^{e+} include H⁺, a carbenium cation, an oxonium cation, an ammonium cation, a phosphonium cation, a cycloheptyltrienyl cation, and a ferrocenium cation having transition metal. R^{f} to Rⁱ may be the same as or different from each other, and each represent an organic group, preferably an aryl group.

Specific examples of the carbenium cation include 3-substituted carbenium cations such as a triphenyl carbenium cation, a tris(methylphenyl) carbenium cation, and a tris(dimethylphenyl) carbenium cation.

Specific examples of the ammonium cation include a trialkyl ammonium cation such as a trimethyl ammonium cation, a triethyl ammonium cation, a tri(n-propyl)ammonium cation, a tri-isopropyl ammonium cation, a tri(n-butyl)ammonium cation, and a tri-isobutyl ammonium cation, a N,N-dialkyl anilinium cation such as an N,N-dimethyl anilinium cation, an N,N-diethyl anilinium cation, and an N,N-2,4,6-pentamethyl anilinium cation, and a dialkyl ammonium cation such as a diisopropyl ammonium cation and a dicyclohexyl ammonium cation.

Specific examples of the phosphonium cation include a triaryl phosphonium cation such as a triphenylphosphonium cation, tris(methylphenyl)phosphonium cation, and tris(dimethylphenyl)phosphonium cation.

Among them, R^{e+} is preferably a carbenium cation, an ammonium cation, or the like, and particularly preferably a triphenylcarbenium cation, a N,N-dimethyl anilinium cation, or an N,N-diethyl anilinium cation.

Specific examples of the carbenium salts include triphenyl carbenium tetraphenylborate, triphenyl carbenium tetrakis(pentafluorophenyl)borate, triphenyl carbenium tetrakis(3,5-ditrifluoromethylphenyl)borate, tris(4-methylphenyl) carbenium tetrakis(pentafluorophenyl)borate, and tris(3,5-dimethylphenyl) carbenium tetrakis(pentafluorophenyl)borate.

Examples of the ammonium salt include a trialkyl-substituted ammonium salt, an N,N-dialkyl anilinium salt, and a dialkyl ammonium salt.

Specific examples of the trialkyl-substituted ammonium salt include triethyl ammonium tetraphenyl borate, tripropyl ammonium tetraphenyl borate, tri(n-butyl)ammonium tetraphenyl borate, trimethyl ammonium tetrakis(p-tolyl)borate, trimethyl ammonium tetrakis(o-tolyl)borate, tri(n-butyl)ammonium tetrakis(pentafluorophenyl)borate, triethyl ammonium tetrakis(pentafluorophenyl)borate, tripropyl ammonium tetrakis(pentafluorophenyl)borate, tripropyl ammonium tetrakis(2,4-dimethylphenyl)borate, tri(n-butyl)ammonium tetrakis(3,5-dimethylphenyl)borate, tri(n-butyl)ammonium tetrakis(4-trifluoromethylphenyl)borate, tri(n-butyl)ammonium tetrakis(3,5-ditrifluoromethylphenyl)borate, tri(n-butyl)ammonium tetrakis(o-tolyl)borate, dioctadecyl methyl ammonium tetraphenyl borate, dioctadecyl methyl ammonium tetrakis(p-tolyl)borate, dioctadecyl methyl ammonium tetrakis(o-tolyl)borate, dioctadecyl methyl ammonium tetrakis(pentafluorophenyl)borate, dioctadecyl methyl ammonium tetrakis(2,4-dimethylphenyl)borate, dioctadecyl methyl ammonium tetrakis(3,5-dimethylphenyl)borate, dioctadecyl methyl ammonium tetrakis(4-trifluoromethylphenyl)borate, dioctadecyl methyl ammonium tetrakis(3,5-ditrifluoromethylphenyl)borate, and dioctadecyl methyl ammonium.

Specific examples of the N,N-dialkyl anilinium salt, include N,N-dimethyl anilinium tetraphenyl borate, N,N-dimethyl anilinium tetrakis(pentafluorophenyl)borate, N,N-dimethyl anilinium tetrakis(3,5-ditrifluoromethylphenyl)borate, N,N-diethyl anilinium tetraphenyl borate, N,N-diethyl anilinium tetrakis(pentafluorophenyl)borate, N,N-diethyl anilinium tetrakis(3,5-ditrifluoromethylphenyl)borate, N,N-2,4,6-pentamethyl anilinium tetraphenyl borate, and N,N-2,4,6-pentamethyl anilinium tetrakis(pentafluorophenyl)borate.

Specific examples of the dialkyl ammonium salt include di(1-propyl)ammonium tetrakis(pentafluorophenyl)borate, and dicyclohexyl ammonium tetraphenyl borate.

The ionic compounds as disclosed in JP-A No. 2004-51676 by the present Applicant can be used without any restriction.

The ionic compounds (b-2) can be used in a mixture of two or more kinds.

<(b-3) Organoaluminum Compound>

Examples of the organoaluminum compound (b-3) which constitutes the catalyst for olefin polymerization include an organoaluminum compound represented by the following formula (X), and an alkylated complex with a metal element from Group 1 of the periodic table and aluminum, which is represented by the following formulas (19) and (20):
R^{a}ₘAl(OR^{b})ₙHₚX_{q} (19)

(wherein R^{a} and R^{b} are may be the same as or different from each other and each represent a hydrocarbon group having usually 1 to 15 carbon atoms, preferably 1 to 4 carbon atoms, X is a halogen atom, and m, n, p, and q are numbers satisfying the conditions: 0<m≦3, 0≦n<3, 0≦p<3, and 0≦q<3, while m+n+p+q=3);

specific examples of the compound represented by the formula (19) include tri-n-alkyl aluminum such as trimethyl aluminum, triethyl aluminum, tri-n-butyl aluminum, trihexyl aluminum, and trioctyl aluminum; tri-branch chained alkyl aluminum such as tri-isopropyl aluminum, tri-isobutyl aluminum, tri-sec-butyl aluminum, tri-tert-butyl aluminum, tri-2-methylbutyl aluminum, tri-3-methyl hexyl aluminum, and tri-2-ethylhexyl aluminum; tri-cycloalkyl aluminum such as tri-cyclohexyl aluminum, and tri-cyclooctyl aluminum; triaryl aluminum such as triphenyl aluminum, and tritolyl aluminum; dialkyl aluminum hydride such as diisopropyl aluminum hydride, and diisobutyl aluminum hydride; alkenyl aluminum, such as isoprenyl aluminum, represented by the formula: (i-C₄H₉)ₓAl_{y}(C₅H₁₀)_{z} (wherein x, y and z are positive integers, and z is the numbers satisfying the conditions: z≦2x); alkyl aluminum alkoxide such as isobutyl aluminum methoxide, and isobutyl aluminum ethoxide; dialkyl aluminum alkoxide such as dimethyl aluminum methoxide, diethyl aluminum ethoxide, and dibutyl aluminum butoxide; alkyl aluminum sesquialkoxide such as ethyl aluminum sesquiethoxide, and butyl aluminum sesquibutoxide; partially alkoxylated alkyl aluminum, for example, having a mean compositions represented by the general formula R^{a}_{2.5}Al(OR^{b})_{0.5}; alkyl aluminum aryloxide such as diethyl aluminum phenoxide, diethyl aluminum (2,6-di-t-butyl-4-methylphenoxide); dialkyl aluminum halide such as dimethyl aluminum chloride, diethyl aluminum chloride, dibutyl aluminum chloride, diethyl aluminum bromide, and diisobutyl aluminum chloride; alkyl aluminum sesquihalide such as ethyl aluminum sesquichloride, butyl aluminum sesquichloride, and ethyl aluminum sesquibromide; partially halogenated alkyl aluminum of alkyl aluminum dihalide such as ethyl aluminum dichloride; dialkyl aluminum hydride such as diethyl aluminum hydride, and dibutyl aluminum hydride; other partially hydrogenated alkyl aluminum, for example, alkyl aluminum dihydrides such as ethyl aluminum dihydride and propyl aluminum dihydride; and partially alkoxylated and halogenated alkyl aluminums such as ethyl aluminum ethoxychloride, butyl aluminum butoxychloride and ethyl aluminum ethoxybromide;
M²AlR^{a}₄ (20)

(wherein M² is Li, Na or K, and R^{a} is a hydrocarbon group having usually 1 to 15 carbon atoms, preferably 1 to 4 carbon atoms). Specific examples of the compounds represented by the formula (20) include LiAl(C₂H₅)₄ and LiAl(C₇H₁₅)₄.

The compounds similar to the compounds represented by the formula (20), for example, the organoaluminum compounds in which two or more aluminum compounds are bonded via a nitrogen atom, can be used. Specific examples thereof include (C₂H₅)₂AlN(C₂H₅)Al(C₂H₅)₂.

From a viewpoint of easy availability, as an organoaluminum compound (b-3), trimethyl aluminum or tri-isobutyl aluminum is preferably used.

<Polymerization>

The polyolefin wax such as polyethylene wax used in the invention is obtained by, for example, homopolymerizing ethylene usually in a liquid phase or homopolymerizing or copolymerizing ethylene and an α-olefin usually in a liquid phase, in the presence of the above-mentioned metallocene catalyst. In the polymerization, the method for using each of the components, and the sequence of addition are arbitrarily selected, but the following methods may be mentioned.

[q1] A method for adding a component (A) alone to a polymerization reactor.

[q2] A method for adding a component (A) and a component (B) to a polymerization reactor in any order.

For the [q2] method, at least two of each catalyst components may be in contact with each other beforehand. At this time, a hydrocarbon solvent is generally used, but an α-olefin may be used as a solvent. The monomers used herein are as previously described.

As the polymerization process, suspension polymerization wherein polymerization is carried out in such a state that the polyethylene wax is present as particles in a solvent such as hexane, or gas phase polymerization wherein a solvent is not used, or solution polymerization wherein polymerization is carried out at a polymerization temperature of not lower than 140° C. in such a state that the polyethylene wax is molten in the presence of a solvent or is molten alone is employable. Among these, solution polymerization is preferable in both aspects of economy and quality.

The polymerization reaction may be carried out as any of a batch process and a continuous process. When the polymerization is carried out as a batch process, the afore-mentioned catalyst components are used in the concentrations described below.

The component (A) in the polymerization of an olefin using the above-described catalyst for olefin polymerization is used in the amount of usually 10⁻⁹ to 10⁻¹ mol/liter, preferably 10⁻⁸ to 10⁻² mol/liter.

The component (b-1) is used in the amount of usually 0.01 to 5,000, preferably 0.05 to 2,000, as a mole ratio of the component (b-1) to all transition metal atoms (M) in the component (A) [(b-1)/M]. The component (b-2) is used in the amount of usually 0.01 to 5,000, preferably 1 to 2,000, as a mole ratio of the ionic compounds in the components (b-2) to all transition metals (M) in the component of (A) [(b-2)/M]. The component (b-3) is used in the amount of usually 1 to 10000, preferably 1 to 5000, as a mole ratio of the component (b-3) to the transition metal atoms (M) in the component (A) [(b-3)/M].

The polymerization reaction is carried out under the conditions of a temperature of usually −20 to +200° C., preferably 50 to 180° C., more preferably 70 to 180° C., and a pressure of more than 0 and not more than 7.8 MPa (80 kgf/cm², gauge pressure), preferably more than 0 and not more than 4.9 MPa (50 kgf/cm², gauge pressure), setting 10 g of wax on the filter.

In the polymerization, ethylene and α-olefin used if necessary are fed to the polymerization system at the ratio of such amount that the polyethylene wax having the above mentioned specific composition. In the polymerization, further, a molecular weight modifier such as hydrogen can be added.

When polymerization is carried out in this manner, a polymer produced is usually obtained as a polymerization solution containing the polymer. Therefore, by treating the polymerization solution in the usual way, a polyolefin wax such as a polyethylene wax is obtained.

As the metallocene catalyst, a catalyst containing the metallocene compound described in “Example 6 of metallocene compound” is preferable.

Also, in the invention, the use of the catalyst containing the metallocene compound represented by “Example 1 of metallocene compound” is preferably used in particular.

When such catalyst is used, the polyolefin wax such as polyethylene wax having the above mentioned properties can be easily obtained.

The shape of polyolefin wax such as polyethylene wax is not limited, but is generally a particle in the state of a powder, a pellet or a tablet.

[Other Component]

In the invention, in addition to the thermoplastic resin (A) and the polyolefin wax (B), additives such as an antioxidant, an ultraviolet absorber, a stabilizer such as a light stabilizer, a metallic soap, a filler, and a flame retardant may be added to a raw material, for the use, if necessary. In addition, the foam molding is possible by adding a foaming agent, and particularly a foam molding at low temperature become possible by the use of a low-temperature foaming agent.

Examples of the stabilizer include an antioxidant such as a hindered phenol compound, a phosphate compound, and a thioether compound;

an ultraviolet absorber such as benzotriazole compound and benzophenone; and

a light stabilizer such as a hindered amine compound.

Examples of the metallic soap include a salt of stearic acid such as magnesium stearate, calcium stearate, barium stearate, and zinc stearate.

Examples of the filler include calcium carbonate, titanium oxide, barium sulfate, talc, clay, and carbon black.

Examples of the flame retardant include a halide such as halogenated diphenyl ether such as decabromdiphenyl ether and octabromdiphenyl ether, and halogenated polycarbonate; an inorganic compound such as antimonyl trioxide, antimonyl tetroxide, antimonyl pentoxide, sodium pyroantimonate, and aluminum hydroxide; and a phosphorus compound.

As flame retardant auxiliaries for preventing a drip, a compound such as tetrafluoroethylene may be added.

Examples of the antibacterial agent and a antifungus agent include an organic compound such as an imidazole compound, a thiazole compound, a nitrile compound, a haloalkyl compound, and a pyridine compound; and

a mineral material or an inorganic compound such as sliver, a silver compound, a zinc compound, a copper compound, and a titanium compound.

Among these compounds, silver or a silver compound which is stable in heat, and has high performance is preferable.

Examples of the silver compound include a silver complex, a silver salt of aliphatic acid, phosphoric acid, and the like. When silever and a sliver compound may be used as the antibacterial agent and the antifungus agent, there is a case that these substance is supported to a porous structure such as zeolite, silica gel, zirconium phosphate, calcium phosphate, hydrotalcite, hydroxyapatite, and silicate calcium.

Examples of other additives include a colorant, a pigment, a plasticizer, an anti-aging agent, and an oil.

[Ratio of Raw Material Composition]

The composition ratio of the thermoplastic resin (A) and the polyolefin wax (B), which are used as the raw material, is not particularly limited as long as the properties of the molded product to be obtained.

In order to obtain a mixture containing the thermoplastic resin and the polyolefin wax and having an L/L₀ in the above range, it is preferable that the polyolefin wax is contained in the proportion of usually 0.5 to 15 part by weight, preferably 1 to 10 parts by weight, and more preferably 2 to 7 parts by weight, based on 100 parts by weight of the thermoplastic resin.

When the polyethylene wax satisfying the condition of above expression (I) is used as the polyolefin wax (B) and the polyethylene (1) is used as the thermoplastic resin (A), the amount of the polyolefin wax satisfying the condition of above expression (I) is usually in the range of 0.01 to 10 parts by weight, preferably in the range of 0.1 to 5 parts by weight, and more preferably in the range of 0.5 to 3 parts by weight, based on 100 parts by weight of the polyethylene (1).

In the case of using the polyethylene (1) and the polyethylene wax in the above range of the composition ratio, the large effect of improving the fluidity is obtained, as compared with the case of adding no polyethylene wax, an injection molded product having a same mechanical properties can be obtained even if the injection molding is performed at low molding temperature, and deterioration of the mechanical properties due to an addition of the wax is prevented. In addition, when the molding is performed at low molding temperature, the cooling time is reduced, and thus the molding cycle can be increased. Furthermore, the heat deterioration of the resin can be prevented by lowering molding temperature, the deterioration of the resin strength can be also prevented, as well as the burn and black dot of the resin can be prevented.

When the polyethylene wax satisfying the condition of above expression (I) is used as the polyolefin wax (B) and the polyethylene (2) is used as the thermoplastic resin (A), the amount of the polyolefin wax satisfying the condition of above expression (1) is usually in the range of 0.01 to 10 parts by weight, preferably in the range of 0.1 to 5 parts by weight, and more preferably in the range of 0.5 to 3 parts by weight, based on 100 parts by weight of the polyethylene (2).

In the case of using the polyethylene (2) and the polyethylene wax in the above range of the composition ratio, the large effect of improving the fluidity is obtained, as compared with the case of adding no polyethylene wax, an injection molded product having a same mechanical properties can be obtained even if the injection molding is performed at low molding temperature, and deterioration of the mechanical properties due to an addition of the wax is prevented. In addition, when the molding is performed at low molding temperature, the cooling time is reduced, and thus the molding cycle can be increased. Furthermore, the heat deterioration of the resin can be prevented by lowering molding temperature, the deterioration of the resin strength can be also prevented, as well as the burn and black dot of the resin can be prevented.

When the polyethylene wax satisfying the condition of above expression (I) is used as the polyolefin wax (B) and the polypropylene is used as the thermoplastic resin (A), the amount of the polyolefin wax satisfying the condition of above expression (I) is usually in the range of 0.01 to 10 parts by weight, preferably in the range of 0.1 to 7 parts by weight, and more preferably in the range of 0.5 to 5 parts by weight, based on 100 parts by weight of the polypropylene.

In the case of using the polypropylene and the polyethylene wax in the above range of the composition ratio, the large effect of improving the fluidity is obtained, as compared with the case of adding no polyethylene wax, an injection molded product having a same mechanical properties can be obtained even if the injection molding is performed at low molding temperature, and deterioration of the mechanical properties due to an addition of the wax is prevented. In addition, when the molding is performed at low molding temperature, the cooling time is reduced, and thus the molding cycle can be increased. Furthermore, the heat deterioration of the resin can be prevented by lowering molding temperature, the deterioration of the resin strength can be also prevented, as well as the burn and black dot of the resin can be prevented.

When the polyethylene wax satisfying the condition of above expression (I) is used as the polyolefin wax (B) and the polypropylene resin mixture (1) is used as the thermoplastic resin (A), the amount of the polyolefin wax satisfying the condition of above expression (I) is usually in the range of 0.01 to 10 parts by weight, and preferably in the range of 1 to 5 parts by weight, based on 100 parts by weight of the polypropylene resin mixture (1).

In the case of using the polyethylene wax to the polypropylene resin mixture (1) in the above range of the composition ratio, the large effect of improving the fluidity and excellent molding property are obtained, the molding speed is further improved, and thus the productivity tend to be improved. Further, the mechanical properties of which the polypropylene resin mixture (1) formed from polypropylene and olefin elastomer originally has, tends not to be lost. In addition, there is a case that the molding at low molding temperature become possible as compared with the case of injection molding by adding no polyethylene wax, and thus the cooling time can be reduced. Furthermore, there is a case that the heat deterioration of the resin can be prevented by lowering molding temperature, the deterioration of the resin strength can be also prevented, as well as the burn and black dot of the resin can be prevented.

[Injection Molding]

In the process for producing the molded product of the invention, the injection molding is performed by the use of the above raw material.

For the injection molding, there is no particular limitation, and the heretofore known process can be applied. In general, the injection molding is performed by the process comprising a melt kneading a raw material such as the thermoplastic resin (A) and the polyolefin wax (B) added through a hopper in a heating cylinder, filling the melt kneaded product into the mold by the use of an injection molding machine, cooling and solidifying the resin composition in the mold, and taking out the molded product from the mold.

The thermoplastic resin (A) and the polyolefin wax (B) may be previously mixed (pre-mixed) prior to feeding them to an injection molding machine, and a polyolefin wax may be fed to the resin fed (for example, from side-fed) to injection molding machine, followed by mixing them. In either of the cases, in the injection, a mixture containing the thermoplastic resin (A) and the polyolefin wax (B) is formed. The premix method is not particularly limited, but a dry blending or a melt blending is adopted. As the machine using for the dry blending, a rapid mixer such as a Henschel mixer, and a tumbler. As the machine used for the melt kneading, Plastmill, Kneader, Roll Mixer, Banbury Mixer, Brabender, Single screw extruder, and Double screw extruder may be exemplified.

In the case of adding no polyolefin wax such as polyethylene wax, for example, the injection molding temperature of the polyethylene (1) is in the range of 140 to 300° C., the injection molding temperature of the polyethylene (2) is in the range of 150 to 300° C., and the injection molding temperature of the polypropylene is in the range of 180 to 300° C.

According to the invention, the injection molding temperature (resin temperature) can be set to the lower temperature by 5° C. or more, preferably 10° C. or more, and more preferably 15° C. or more, relative to the injection molding temperature in the case of adding no polyolefin wax such as polyethylene wax. Herein, the term “the injection molding temperature in the case of containing no polyolefin wax such as polyethylene wax” means the suitable injection molding temperature which is arbitrarily determined depending on the thermoplastic resin (A) such as polyolefin resin to be used, considering the molding speed and the properties of the molded product to be obtained. For example, in the case of crystalline polyethylene and crystalline polypropylene, the suitable injection molding temperature Tr can be determined from the crystal melting temperature Tm, by the following expression:
Tr=3/4×Tm+100

wherein Tm represents a melting temperature (° C.) of the thermoplastic resin, particularly crystal melting point (° C.) for a crystalline resin.

The term “the injection molding temperature in the case of containing polyolefin wax such as polyethylene wax” means the injection molding temperature which can give the same screw torque as the screw torque of the extruder at the injection molding temperature in the case of containing no polyolefin wax such as polyethylene wax. Here, the term “the same” includes an error in the range of about 5%.

As described above, if lowering the molding temperature is possible, the burn in the injection molding can be prevented. Further, for the injection molded product, the deterioration of the properties cannot be observed even if polyolefin wax such as polyethylene wax is added. Furthermore, the molding temperature can be lowered, thus the cooling time of mold is reduced. As the result, the molding cycle can be increased, and the improvement of the productivity in the existing facilities, become possible. In addition, the injection molding can be performed at low temperature, and thus the foaming at low temperature become possible.

The injection temperature of the invention is in the range of usually 180 to 400° C., preferably 200 to 300° C., more preferably 200 to 250° C., and the injection pressure is in the range of usually 10 to 200 MPa, preferably 20 to 150 MPa. Further, the mold temperature is in the range of usually 20 to 200° C., preferably 20 to 80° C., and more preferably 20 to 60° C. For the condition for the injection molding except the injection molding temperature and the like, the heretofore known conditions can be employed.

In the case of using the polypropylene resin mixture (1) as the thermoplastic resin (A), the injection molding temperature is usually in the range of 180 to 300° C., and preferably in the range of 180 to 250° C.

In the case of using the polyethylene (1) as the thermoplastic resin (A), the injection pressure is in the range of usually 30 to 100 MPa, preferably 30 to 50 MPa, and the mold temperature is in the range of usually 20 to 40° C., and preferably 25 to 35° C.

In the case of using the polyethylene (2) as the thermoplastic resin (A), the injection pressure is in the range of usually 30 to 150 MPa, preferably 30 to 100 MPa, and the mold temperature is in the range of usually 20 to 40° C., and preferably 25 to 35° C.

In the case of using the polypropylene as the thermoplastic resin (A), the injection pressure is in the range of usually 40 to 150 MPa, preferably 50 to 80 MPa, and the mold temperature is in the range of usually 20 to 80° C., and preferably 30 to 60° C.

In the case of using the polypropylene resin mixture (1) as the thermoplastic resin (A), the injection pressure is in the range of usually 40 to 150 MPa, preferably 50 to 80 MPa, and the mold temperature is in the range of usually 20 to 80° C., and preferably 50 to 60° C.

As described above, the molded product useful for a building material, a vehicle part, an industrial part, an electrical and electronic part can be obtained.

### Examples

The present invention is further described with reference to the following examples, but it should be construed that the invention is in no way limited to those examples.

In the following examples, the properties of the polyethylene and the polyethylene wax are measured as follows.

(Number Average Molecular Weight (Mn))

The number-average molecular weight (Mn) is measured by a GPC measurement. The measurement is performed under the following conditions. In addition, the number-average molecular weight (Mn) is determined by firstly preparing a calibration curve by the use of the commercially available monodisperse standard polystyrene, and calculating by the following conversion method.

Appliance: Gel permeation chromatograph Alliance GPC2000 model (manufactured by Waters Co., Ltd.)

Solvent: o-dichlorobenzene

Column: TSKgel column (manufactured by TOSOH Corporation)×4

Flow rate: 1.0 ml/min.

Sample: 0.15 mg/mL of o-dichlorobenzene

Temperature: 140° C.

Molecular weight conversion: PE conversion/general calibration approach

For the calculation of general calibration approach, a coefficient of Mark-Houwink viscosity expression as shown below is used.

Coefficient of polystyrene (PS): KPS=1.38×10⁻⁴, aPS=0.70

Coefficient of polyethylene (PE): KPE=5.06×10⁻⁴, aPE=0.70

(A Value and B Value)

From the results measured by the GPC as described above, a ratio of the component having a molecular weight of 1,000 or less was determined in % by weight, which was employed as the A value. From the results measured by the GPC, a ratio of the component having a molecular weight of 20,000 or more was determined in % by weight, which was employed as the B value.

(Melt Viscosity)

The melt viscosity was measured at 140° C. by the use of the Brookfield (B type) viscometer.

(Density)

The density was measured in accordance with the density gradient tube process of JIS K7112.

(Melting Point)

The melting point was measured by the use of a differential scanning calorimetry (DSC) [DSC-20 (manufactured by Seiko Instrument & Electronics Ltd.)]. A sample to be measured was once heated to 200° C., maintained at the same temperature for 5 minutes, and then immediately cooled back to room temperature. About 10 mg of the sample was measured under the conditions at the temperature in the range of −20° C. to 200° C., at the heating rate of 10° C./min., by the use of the DSC. A value of the endothermic peak of the curve obtained from the measurement results was employed as the melting point.

(Crystal Melting Point)

The crystal melting point (Tₘ, ° C.) was measured under the condition of the cooling rate of 2° C./min., in accordance with ASTM D 3417-75.

(MI)

In the case of using the polyethylene (1) and the polyethylene (2):

the MI was measured under the conditions at 190° C. and a test load of 21.18N in accordance with JIS K7210.

In the case of using the polypropylene:

the MI was measured under the conditions at 230° C. and a test load of 21.18N in accordance with JIS K7210.

In the case of using the ethylene.α-olefin random copolymer:

the MI was measured under the conditions at 190° C. and a test load of 21.18N in accordance with JIS K7210.

In the case of using the propylene.α-olefin random copolymer:

the MI was measured under the conditions at 230° C. and a test load of 21.18N in accordance with JIS K7210.

(Synthesis of Polyethylene Wax (1))

The polyethylene wax (1) was synthesized by the use of the metallocene catalyst as described as follows.

770 ml of hexane and 115 g of propylene were charged to a stainless autoclave having the internal volume of 2 L thoroughly charged with nitrogen and maintained at 25° C. Subsequently, the temperature of the internal system was elevated to 150° C., 0.3 mmol of triisobutyl aluminum, 0.04 mmol of dimethylaniliniumtetrakis(pentafluorophenyl)borate, and 0.0005 mmol of bis(cyclopentadienyl)zirconium dichloride and ethylene was injected to initiate the polymerization. Thereafter, the total pressure was maintained at 3.0 MPa (gauge pressure) by continuously supplying ethylene alone, and the polymerization was carried out at 155° C. for 30 minutes.

A small amount of ethanol was added into the system to stop the polymerization, and unreacted ethylene was purged. The obtained polymer solution was dried under reduced pressure at 100° C. over night to obtain 46 g of the polyethylene wax (1). The obtained polyethylene wax (1) has a number average molecular weight (Mn) of 800, a weight average molecular weight (Mw) of 1,500, a melt viscosity of 40 mPa·S, a density of 897 kg/m³, and a melting point of 78.8° C. Here, the A value is 23.5% by weight and the B value is 0.01% by weight. The results is shown in the Table 1.

(Synthesis of Polyethylene Wax (2))

The polyethylene wax (2) was synthesized by the use of the metallocene catalyst as described as follows.

700 ml of hexane and 150 g of propylene were charged to a stainless autoclave having the internal volume of 2 L thoroughly charged with nitrogen and maintained at 25° C. Subsequently, the temperature of the internal system was elevated to 140° C., 0.3 mmol of triisobutyl aluminum, 0.04 mmol of dimethylaniliniumtetrakis(pentafluorophenyl)borate, and 0.0002 mmol of bis(cyclopentadienyl)zirconium dichloride and ethylene was injected to initiate the polymerization. Thereafter, the total pressure was maintained at 3.0 MPa (gauge pressure) by continuously supplying ethylene alone, and the polymerization was carried out at 140° C. for 30 minutes.

A small amount of ethanol was added into the system to stop the polymerization, and unreacted ethylene was purged. The obtained polymer solution was dried under reduced pressure at 100° C. over night to obtain 40 g of the polyethylene wax (2). The obtained polyethylene wax (2) has a number average molecular weight (Mn) of 2,500, a weight average molecular weight (Mw) of 7,000, a melt viscosity of 600 mPa·S, a density of 880 kg/m³, and a melting point of 68.2° C. Here, the A value is 7.0% by weight and the B value is 4.1% by weight. The results are shown in the Table 1.

(Synthesis of Polyethylene Wax (3))

The polyethylene wax (2) was synthesized by the use of the metallocene catalyst as described as follows.

920 ml of hexane and 50 g of propylene were charged to a stainless autoclave having the internal volume of 2 L thoroughly charged with nitrogen and maintained at 25° C. Subsequently, the temperature of the internal system was elevated to 150° C., 0.3 mmol of triisobutyl aluminum, 0.04 mmol of dimethylaniliniumtetrakis(pentafluorophenyl)borate, and 0.0002 mmol of bis(cyclopentadienyl)zirconium dichloride and ethylene was injected to initiate the polymerization. Thereafter, the total pressure was maintained at 3.0 MPa (gauge pressure) by continuously supplying ethylene alone, and the polymerization was carried out at 150° C. for 30 minutes.

A small amount of ethanol was added into the system to stop the polymerization, and unreacted ethylene was purged. The obtained polymer solution was dried under reduced pressure at 100° C. over night to obtain 40 g of the polyethylene wax (2). The obtained polyethylene wax (3) has a number average molecular weight (Mn) of 3,000, a weight average molecular weight (Mw) of 8,200, a melt viscosity of 1,000 mPa·S, a density of 932 kg/m³, and a melting point of 105.0° C. Here, the A value is 4.6% by weight and the B value is 6.7% by weight. The results are shown in the Table 1.

The properties of the polyethylene wax used in the present invention are shown in the Table 1.

TABLE 1
Value indicating the properties of the polyolefin wax

| | | | | | | | | | | | Value in |
|---|---|---|---|---|---|---|---|---|---|---|---|
| | | | | | | | | | DSC | DSC | left side |
| | | | | Melt | B | A | | | melting | crystallization | of |
| | | | Density | viscosity K | value | value | | | point | temperature | expression |
| | Mn | Mw | (kg/m³) | (mPa · S) | (%) | (%) | 0.0075 × K | 230 × K^{-0.537} | (° C.) | (° C.) | (III) |
| 30200BT | 2000 | 5000 | 913 | 300 | 2.2 | 9.3 | 2.3 | 10.8 | 98.2 | 86.6 | 91.41 |
| 48070BT | 3400 | 9000 | 902 | 1350 | 8.7 | 4.7 | 10.1 | 4.8 | 89.5 | 83.8 | 85.90 |
| 40800T | 2400 | 7000 | 980 | 600 | 4.2 | 7.3 | 4.5 | 7.4 | 127.7 | 116.2 | 124.98 |
| Polyethylene | 800 | 1500 | 897 | 40 | 0.01 | 23.5 | 0.3 | 31.7 | 78.8 | 62.9 | 83.40 |
| wax (1) | | | | | | | | | | | |
| Polyethylene | 2500 | 7000 | 880 | 600 | 4.1 | 7.0 | 4.5 | 7.4 | 68.2 | 56.8 | 74.88 |
| wax (2) | | | | | | | | | | | |
| Polyethylene | 3000 | 8200 | 932 | 1000 | 6.7 | 4.6 | 7.5 | 5.6 | 105.0 | 95.2 | 100.93 |
| wax (3) | | | | | | | | | | | |
| 420P | 2000 | 6400 | 930 | 700 | 6.2 | 8.3 | 5.3 | 6.8 | 112.3 | 1018 | 99.93 |
| 400P | 2200 | 6000 | 978 | 620 | 5.3 | 8.9 | 4.7 | 7.3 | 128.1 | 116.4 | 123.98 |
| A-C6 | 1800 | 6500 | 913 | 420 | 3.3 | 6.5 | 3.2 | 9.0 | 103.2 | 92.3 | 91.41 |

The physical properties or the molded product were evaluated as follows.

[Evaluation of Physical Properties]

(Releasability)

By means of the injection molding machine, under the above-described conditions, a plane (110 mm in length×120 mm in width×2 mm in thick) was made by injection molding, and then cooled for a predetermined time. Thereafter, the molded article in the mold was pushed out with a pin, upon which the releasability was evaluated based on the following criteria.

◯: The molded article is demolded without resistance, but is not deformed.

x: The molded article is deformed with large release resistance due to adherence to a mold, or the like.

(Flow Mark)

A plane (110 mm in length×120 mm in width×2 mm in thick) was made by injection molding using the injection molding machine under the above-described conditions, and then flow mark was observed.

◯: The flow mark is not observed.

x: The flow mark is observed.

(Tensile Fracture Stress and Tensile Yield Stress)

A test specimen (IBA shape of test specimen) was prepared using the injection molding machine under the above-described conditions, and a tensile fracture stress and a tensile yield stress thereof were measured at a tensile rate of 50 mm/min, in accordance with JIS K7161.

(Flexural Elastic Modulus, and Flexural Strength)

A test specimen was prepared using the injection molding machine under the above-described conditions, and a flexural elastic modulus and a flexural strength thereof were measured under the conditions of a distance between supporting points of 48 mm, and a test speed of 5.0 mm/min, in accordance with JIS K7171.

(Heat Resistance)

A test specimen was prepared using the injection molding machine under the above-described conditions, and a Vicat softening point thereof was measured in accordance with JIS K7206.

(Deflection Temperature Under Load)

A edgewise test specimen (test specimen: 125 mm in length, 12.5 mm in width, and 3.2 mm in thick) was prepared under the injection condition to be described in Examples to be described later, and a deflection temperature under load thereof was measured under the conditions of a load condition B method 0.45 MPa, and a distance between supporting points of 100 mm, in accordance with JIS K7191 edgewise method.

(Impact Resistance)

A test specimen (type 1A test specimen with notch) was prepared using an injection molding machine under the above conditions, and an Izod impact strength thereof was measured in accordance with JIS K7110.

### Example of Polyethylene (1)

### Comparative Example 1A

For low-density polyethylene (product name: MIRASON 403P manufactured by PRIME POLYMER Co., Ltd, crystal melting point: 108° C., density: 921 kg/m³, MI: 7.0 g/10 min.), a molded article was prepared by injection molding under the following conditions, and various physical properties were evaluated. The results are shown in Table 2.

[Condition for Injection Molding]

Injection molding machine: manufactured by Toshiba Machine Co., Ltd., 55 ton injection molding machine (IS55EPNi1.5B),

Molding temperature (preset temperature of cylinder): 180° C.

Injection pressure: 35 MPa,

Injection speed: 80 mm/sec

Injection time: 15 sec.

Mold temperature: 30° C.

Cooling time of mold: 20 seconds.

### Comparative Example 2A

The injection molding of low-density polyethylene (MIRASON 403P) was tried in the same manner as the Comparative Example 1A, except that the molding temperature was changed to 160° C., but an excellent molded product was not obtained due to the short shot.

### Comparative Example 3A

To 100 parts by weight of low-density polyethylene (MIRASON 403P), 2 parts by weight of Ziegler polyethylene wax (product name: Hi-wax (registered trademark) 420P), manufactured by Mitsui Chemicals, Inc., content of ethylene: 97 mol %, density: 930 kg/m³, average molecular weight (Mn): 2000, melt viscosity (140° C.): 700 mPa·s, A value: 8.3% by weight, and B value: 6.2% by weight) prepared by using a Ziegler catalyst was added, and then sufficiently mixed in a tumbler mixer to prepare a mixture of low-density polyethylene and polyethylene wax.

The injection molding was performed in the same manner as the Comparative Example 1A, except that the mixture was used instead of low-density polyethylene (MIRASON 403P), the molding temperature was changed to 160° C., and the cooling time of mold was changed to 15 seconds, and various physical properties were evaluated. The results are shown in Table 2.

### Example 1A

The injection molding was performed in the same manner as the Comparative Example 3A, except that 2 parts by weight of metallocene polyethylene wax (product name: EXCEREX (registered trademark) 48070BT, manufactured by Mitsui Chemicals, Inc., content of ethylene: 92 mol %, density: 902 kg/m³, average molecular weight (Mn): 3400, melt viscosity (140° C.): 1350 mPa·s, A value: 4.7% by weight, and B value: 8.7% by weight) prepared by the use of a metallocene catalyst, was used instead of Ziegler polyethylene wax (Hi-wax (registered trademark) 420P), and various physical properties were evaluated. The results are shown in Table 2.

[Table 2]

TABLE 2

| | | Comparative | Comparative | Comparative | Example |
|---|---|---|---|---|---|
| | | Example 1A | Example 2A | Example 3A | 1A |
| Additive amount | | 0 | 0 | 0 | 2 |
| (parts by weight) of | | | | | |
| EXCEREX 48070BT | | | | | |
| Additive amount | | 0 | 0 | 2 | 0 |
| (parts by weight) of Hi-wax 420P | | | | | |
| Molding | | 180 | 160 | 160 | 160 |
| temperature (° C.) | | | | | |
| Cooling time of | | 20 | — | 15 | 15 |
| mold (sec) | | | | | |
| Releasability | | ◯ | — | X | ◯ |
| Flow mark | | ◯ | — | ◯ | ◯ |
| Tensile fracture | | 18 | — | 14 | 18 |
| stress (MPa) | | | | | |
| Flexural elastic | | 149 | — | 119 | 149 |
| modulus(MPa) | | | | | |
| Flexural | | 8.8 | — | 7.0 | 8.7 |
| strength (MPa) | | | | | |
| Vicat softening | | 94 | — | 90 | 93 |
| point (° C.) | | | | | |
| Izod impact | 23° C. | 520 | — | 416 | 518 |
| strength (J/m) | | | | | |

In comparison of Example 1A with comparative Examples 1A and 2A, it is seen that when polyethylene wax is added to low-density polyethylene, the injection molding is possible without deterioration of the properties of the molded article even in the case of lowering molding temperature by 20° C. or more as compared with the case of adding no polyethylene wax. Further, it is also seen that the cooling time of mold can be reduced. In addition, in comparison of Example 1A with Comparative Example 3A, it is seen that when polyethylene wax obtained by the use of the catalyst satisfying the relation of the expression (I) between the melt viscosity and the B value and satisfying the expression (II) between the melt viscosity and the A value is added to low-density polyethylene, the injection molded article having an excellent mechanical property can be prepared, as compared with the case of using a conventional wax, and the releasability from the mold is also excellent.

### Example of Polyethylene (2)

### Comparative Example 1B

For high-density polyethylene (product name: Hi-zex 2100JH manufactured by PRIME POLYMER Co., Ltd, crystal melting point: 131° C., density: 952 kg/m³, MI: 9.0 g/10 min.), a molded article was prepared by injection molding under the following conditions, and various physical properties were evaluated. The results are shown in Table 3.

[Condition for Injection Molding]

Injection molding machine: manufactured by Toshiba Machine Co., Ltd., 55 ton injection molding machine (IS55EPNi1.5B),

Molding temperature (preset temperature of cylinder): 200° C.

Injection pressure: 35 MPa,

Injection speed: 80 mm/sec

Injection time: 15 sec.

Mold temperature: 30° C.

Cooling time of mold: 20 seconds.

### Comparative Example 2B

The injection molding of high-density polyethylene (Hi-zex 2100JH) was tried in the same manner as the Comparative Example 1B, except that the molding temperature was changed to 170° C., but an excellent molded product was not obtained due to the short shot.

### Comparative Example 3B

To 100 parts by weight of high-density polyethylene (Hi-zex 2100JH), 2 parts by weight of Ziegler polyethylene wax (product name: Hi-wax (registered trademark) 400P), manufactured by Mitsui Chemicals, Inc., content of ethylene: 99 mol %, density: 978 kg/m³, average molecular weight (Mn): 2200, melt viscosity (140° C.): 620 mPa·s, A value: 8.9% by weight, and B value: 5.3% by weight) prepared by using a Ziegler catalyst was added, and then sufficiently mixed in a tumbler mixer to prepare a mixture of high-density polyethylene and polyethylene wax.

The injection molding was performed in the same manner as the Comparative Example 1B, except that the mixture was used instead of high-density polyethylene (Hi-zex 2100JH), the molding temperature was changed to 170° C., and the cooling time of mold was changed to 15 seconds, and various physical properties were evaluated. The results are shown in Table 3.

### Example 1B

The injection molding was performed in the same manner as the Comparative Example 3B, except that 2 parts by weight of metallocene polyethylene wax (product name: EXCEREX (registered trademark) 40800T, manufactured by Mitsui Chemicals, Inc., content of ethylene: 99 mol %, density: 980 kg/m³, average molecular weight (Mn): 2400, melt viscosity (140° C.): 600 mPa·s, A value: 7.3% by weight, and B value: 4.2% by weight) prepared by the use of a metallocene catalyst, was used instead of Ziegler polyethylene wax (product name: Hi-wax (registered trademark) 400P), and various physical properties were evaluated. The results are shown in Table 3.

[Table 3]

TABLE 3

| | | Comparative | Comparative | Comparative | Example |
|---|---|---|---|---|---|
| | | Example 1B | Example 2 B | Example 3 B | 1B |
| Additive amount | | 0 | 0 | 0 | 2 |
| (parts by weight) of | | | | | |
| EXCEREX 40800T | | | | | |
| Additive amount | | 0 | 0 | 2 | 0 |
| (parts by weight) of Hi-wax 400P | | | | | |
| Molding | | 200 | 170 | 170 | 170 |
| temperature (° C.) | | | | | |
| Cooling time of mold (sec) | | 20 | — | 15 | 15 |
| Releasability | | ◯ | — | X | ◯ |
| Flow mark | | ◯ | — | ◯ | ◯ |
| Tensile fracture | | 22 | — | 18 | 22 |
| stress (MPa) | | | | | |
| Tensile Yield | | 15 | — | 13 | 14 |
| Stress (MPa) | | | | | |
| Flexural elastic | | 846 | — | 677 | 845 |
| modulus(MPa) | | | | | |
| Flexural | | 23 | — | 19 | 23 |
| strength (MPa) | | | | | |
| Vicat softening | | 122 | — | 118 | 122 |
| point (° C.) | | | | | |
| Izod impact | 23° C. | 62 | — | 58 | 62 |
| strength (J/m) | | | | | |

### Comparative Example 4B

The injection molding was performed in the same manner as the Comparative Example 1B, except that straight chain polyethylene (product name: ULTZEX 4570 manufactured by PRIME POLYMER Co., Ltd, crystal melting point: 127° C., density: 945 kg/m³, MI: 7.0 g/10 min.), was used instead of high-density polyethylene (Hi-zex 2100JH, and various physical properties were evaluated. The results are shown in Table 4.

### Comparative Example 5B

The injection molding of straight chain polyethylene (ULTZEX 4570) was tried in the same manner as the Comparative Example 4B, except that the molding temperature was changed to 170° C., but an excellent molded product was not obtained due to the short shot.

### Comparative Example 6B

2 parts by weight of Ziegler polyethylene wax (Hi-wax (registered trademark) 420P) was added to 100 parts by weight of straight chain polyethylene (ULTZEX 4570), and thoroughly mixed in a tumbler mixer to obtain a mixture of straight chain polyethylene and polyethylene wax.

The injection molding was performed in the same manner as the Comparative Example 4B, except that the mixture was used instead of straight chain polyethylene (ULTZEX 4570), the molding temperature was changed to 170° C., and the cooling time of mold was changed to 15 seconds, and various physical properties were evaluated. The results are shown in Table 4.

### Example 2B

The injection molding was performed in the same manner as the Comparative Example 6B, except that 2 parts by weight of metallocene polyethylene wax (EXCEREX (registered trademark) 48070BT) was used instead of Ziegler polyethylene wax (Hi-wax (registered trademark) 420P), and various physical properties were evaluated. The results are shown in Table 4.

[Table 4]

TABLE 4

| | | Comparative | Comparative | Comparative | Example |
|---|---|---|---|---|---|
| | | Example 4B | Example 5B | Example 6B | 2B |
| Additive amount | | 0 | 0 | 0 | 2 |
| (parts by weight) of | | | | | |
| EXCEREX 48070BT | | | | | |
| Additive amount | | 0 | 0 | 2 | 0 |
| (parts by weight) of Hi-wax 420P | | | | | |
| Molding | | 200 | 170 | 170 | 170 |
| temperature (° C.) | | | | | |
| Cooling time of mold (sec) | | 20 | — | 15 | 15 |
| Releasability | | ◯ | — | X | ◯ |
| Flow mark | | ◯ | — | ◯ | ◯ |
| Tensile fracture | | 18 | — | 14 | 17 |
| stress (MPa) | | | | | |
| Tensile Yield | | 29 | — | 23 | 28 |
| Stress (MPa) | | | | | |
| Flexural elastic | | 650 | — | 520 | 652 |
| modulus(MPa) | | | | | |
| Flexural | | 19 | — | 15 | 19 |
| strength (MPa) | | | | | |
| Vicat softening | | 114 | — | 110 | 114 |
| point (° C.) | | | | | |
| Izod impact | 23° C. | 771 | — | 617 | 772 |
| strength (J/m) | | | | | |

In comparison of Example 1B with Comparative Examples 1B and 2B, and in comparison of Example 2B with comparative Examples 4B and 5B, it is seen that when polyethylene wax is added to high-density polyethylene, the injection molding is possible without deterioration of the properties of the molded article even in the case of lowering molding temperature by 30° C. as compared with the case of adding no polyethylene wax. It is also seen that the cooling time of mold can be reduced. In addition, in comparison of Example 1B with Comparative Example 3B, and in comparison of Example 2B with Comparative Example 6B it is seen that when polyethylene wax obtained by the use of the catalyst satisfying the relation of the expression (I) between the melt viscosity and the B value and satisfying the expression (II) between the melt viscosity and the A value is added to high-density polyethylene, the injection molded article having an excellent mechanical property can be prepared, as compared with the case of using a conventional wax, and the releasability from the mold is also excellent.

### Example of Polypropylene

### Comparative Example 1C

For propylene block copolymer (product name: PRIME POLYPRO J704WA, manufactured by PRIME POLYMER Co., Ltd., crystal melting temperature: 160° C.), a molded article was prepared by injection molding under the following conditions, and various physical properties were evaluated. The results are shown in Table 5.

[Condition for Injection Molding]

Injection molding machine: manufactured by Toshiba Machine Co., Ltd., 55 ton injection molding machine (IS55EPNi1.5B),

Molding temperature: 220° C.

Injection pressure: 105 MPa,

Mold temperature: 40° C.

Cooling time of mold: 20 seconds.

[Evaluation of Physical Properties]

(Releasability)

By means of the injection molding machine, under the above-described conditions, a plane (100 mm×100 mm×3 mm in thick) was made by injection molding, and then cooled for a predetermined time. Thereafter, the molded article in the mold was pushed out with a pin, upon which the releasability was evaluated based on the following criteria.

◯: The molded article is demolded without resistance, but is not deformed.

x: The molded article is deformed with large release resistance due to adherence to a mold, or the like.

(Flow Mark)

A plane (100 mm×100 mm×3 mm in thick) was made by injection molding using the injection molding machine under the above-described conditions, and then flow mark was observed.

◯: The flow mark is not observed.

x: The flow mark is observed.

(Tensile Yield Stress)

A test specimen was prepared using the injection molding machine under the above-described conditions, and a tensile yield stress thereof was measured at a tensile rate of 50 mm/min, in accordance with JIS K7161.

(Flexural Elastic Modulus, and Flexural Strength)

A test specimen was prepared using the injection molding machine under the above-described conditions, and a flexural elastic modulus and a flexural strength thereof were measured under the conditions of a distance between supporting points of 48 mm, and a test speed of 5.0 mm/min, in accordance with JIS K7171.

(Heat Resistance)

A test specimen was prepared using the injection molding machine under the above-described conditions, and a Vicat softening point thereof was measured in accordance with JIS K7206.

(Impact Resistance)

A type 1A test specimen with notch was prepared using an injection molding machine under the above conditions, and an Izod impact strength thereof was measured in accordance with JIS K7110.

### Comparative Example 2C

The injection molding of propylene block copolymer (PRIME POLYPRO J704WA) was tried in the same manner as the Comparative Example 1C, except that the molding temperature was changed to 190° C., but an excellent molded product was not obtained due to the short shot.

### Examples 1C and 2C

To 100 parts by weight of Propylene block copolymer (PRIME POLYPRO J704WA), 1 part by weight or 3 parts by weight of a metallocene polyethylene wax (EXCEREX (Registered Trademark) 30200BT, manufactured by Mitsui Chemical Inc., content of ethylene: 95 mol %, density: 913 kg/m³, average molecular weights (Mn)=2000, melt viscosity (140° C.): 300 mPa·s, A value: 9.3% by weight, and B value: 2.2% by weight) prepared by using a metallocene catalyst was added, and then sufficiently mixed in a tumbler mixer to prepare a mixture of the polypropylene and the polyethylene wax.

The injection molding was performed in the same manner as the Comparative Example 1C, except that the mixture was used instead of propylene block copolymer (PRIME POLYPRO J704WA), the molding temperature was changed to 190° C., and the cooling time of mold was changed to 15 seconds, and various physical properties were evaluated. The results are shown in Table 5.

[Table 5]

TABLE 5

| | | | | Exam- | Exam- |
|---|---|---|---|---|---|
| | | Comparative | Comparative | ple | ple |
| | | Example 1C | Example 2C | 1C | 2C |
| Additive amount | | 0 | 0 | 1 | 3 |
| (parts by weight) | | | | | |
| of EXCEREX 30200BT | | | | | |
| Molding temperature | | 220 | 190 | 190 | 190 |
| (° C.) | | | | | |
| Cooling time of | | 20 | — | 15 | 15 |
| mold (sec) | | | | | |
| Releasability | | ◯ | — | ◯ | ◯ |
| Flow mark | | ◯ | — | ◯ | ◯ |
| Tensile Yield | | 32 | — | 31 | 31 |
| Stress (MPa) | | | | | |
| Flexural elastic | | 1400 | — | 1410 | 1390 |
| modulus(MPa) | | | | | |
| Flexural strength | | 44 | — | 43 | 43 |
| (MPa) | | | | | |
| Vicat softening | | 153 | — | 150 | 149 |
| point (° C.) | | | | | |
| Izod impact | −30° C. | 38 | — | 35 | 36 |
| strength | 23° C. | 95 | — | 97 | 94 |
| (J/m) | | | | | |

### Comparative Example 3C

For propylene homopolymer (product name: PRIME POLYPRO J106G, manufactured by PRIME POLYMER Co., Ltd., crystal melting temperature: 160° C.), a molded article was prepared by injection molding under the following conditions, and various physical properties were evaluated. The results are shown in Table 6.

[Condition for Injection Molding]

Injection molding machine: manufactured by Toshiba Machine Co., Ltd., 55 ton injection molding machine (IS55EPNi1.5B),

Molding temperature: 220° C.

Injection pressure: 20 MPa,

Injection speed: 80 mm/sec

Injection time: 15 sec.

Mold temperature: 40° C.

Cooling time of mold: 20 seconds.

[Evaluation of Physical Properties]

(Releasability)

By means of the injection molding machine, under the above-described conditions, a plane (110 mm in length×120 mm in width×2 mm in thick) was made by injection molding, and then cooled for a predetermined time. Thereafter, the molded article in the mold was pushed out with a pin, upon which the releasability was evaluated based on the following criteria.

◯: The molded article is demolded without resistance, but is not deformed.

x: The molded article is deformed with large release resistance due to adherence to a mold, or the like.

(Flow Mark)

A plane (110 mm in length×120 mm in width×2 mm in thick) was made by injection molding using the injection molding machine under the above-described conditions, and then flow mark was observed.

◯: The flow mark is not observed.

x: The flow mark is observed.

(Tensile Yield Stress)

A test specimen was prepared using the injection molding machine under the above-described conditions, and a tensile yield stress thereof was measured at a tensile rate of 50 mm/min, in accordance with JIS K7161.

(Flexural Elastic Modulus, and Flexural Strength)

A test specimen was prepared using the injection molding machine under the above-described conditions, and a flexural elastic modulus and a flexural strength thereof were measured under the conditions of a distance between supporting points of 48 mm, and a test speed of 5.0 mm/min, in accordance with JIS K7171.

(Heat Resistance)

A test specimen was prepared using the injection molding machine under the above-described conditions, and a deflection temperature under load thereof was measured under the condition of a distance between supporting points of 48 mm, in accordance with JIS K7191.

(Impact Resistance)

A type 1A test specimen with notch was prepared using an injection molding machine under the above conditions, and an Izod impact strength thereof was measured in accordance with JIS K7110.

### Comparative Example 4C

The injection molding of propylene homopolymer (PRIME POLYPRO J106G) was tried in the same manner as the Comparative Example 3C, except that the molding temperature was changed to 190° C., but an excellent molded product was not obtained due to the short shot.

### Comparative Example 5C

To 100 parts by weight of propylene homopolymer (PRIME POLYPRO J106G), 2 parts by weight of a Ziegler polyethylene wax (Hi-wax (Registered Trademark) 420P, manufactured by Mitsui Chemical Inc., content of ethylene: 97 mol %, density: 930 kg/m³, average molecular weights (Mn): 2000, melt viscosity (140° C.): 700 mPa·s, A value: 8.3% by weight, and B value: 6.2% by weight) prepared by using a Ziegler catalyst was added, and then sufficiently mixed in a tumbler mixer to prepare a mixture of the polypropylene and the polyethylene wax.

The injection molding was performed in the same manner as the Comparative Example 3C, except that the mixture was used instead of propylene homopolymer (PRIME POLYPRO J106G), the molding temperature was changed to 190° C., and the cooling time of mold was changed to 15 seconds, and various physical properties were evaluated. The results are shown in Table 6.

### Example 3C

The injection molding was performed in the same manner as the Comparative Example 5C, except that 2 parts by weight of metallocene polyethylene wax (EXCEREX (registered trademark) 30200BT) was used instead of Ziegler polyethylene wax (Hi-wax (registered trademark) 420P), and various physical properties were evaluated. The results are shown in Table 6.

### Example 4C

The injection molding was performed in the same manner as the Example 3, except that 2 parts by weight of metallocene polyethylene wax (EXCEREX (registered trademark) 48070BT, manufactured by Mitsui Chemicals, Inc., content of ethylene: 92 mol %, density: 902 kg/m³, average molecular weight (Mn): 3400, melt viscosity (140° C.): 1350 mPa·s, A value: 4.7% by weight, and B value: 8.7% by weight) prepared by the use of a metallocene catalyst, was used instead of metallocene polyethylene wax (EXCEREX (registered trademark) 30200BT), and various physical properties were evaluated. The results are shown in Table 6.

[Table 6]

TABLE 6

| | | Comparative | Comparative | Comparative | Example | Example |
|---|---|---|---|---|---|---|
| | | Example 3C | Example 4C | Example 5C | 3C | 4C |
| Additive amount | | 0 | 0 | 0 | 2 | ∘ |
| (parts by weight) | | | | | | |
| of EXCEREX 30200BT | | | | | | |
| Additive amount | | 0 | 0 | 0 | 0 | 2 |
| (parts by weight) | | | | | | |
| of EXCEREX 48070BT | | | | | | |
| Additive amount | | 0 | 0 | 2 | 0 | 0 |
| (parts by weight) | | | | | | |
| of Hi-wax 420P | | | | | | |
| Molding temperature | | 220 | 190 | 190 | 190 | 190 |
| (° C.) | | | | | | |
| Cooling time of | | 20 | — | 15 | 15 | 15 |
| mold (sec) | | | | | | |
| Releasability | | ◯ | — | X | ◯ | ◯ |
| Flow mark | | ◯ | — | ◯ | ◯ | ◯ |
| Tensile Yield | | 37 | — | 30 | 36 | 36 |
| Stress (MPa) | | | | | | |
| Flexural elastic | | 1590 | — | 1270 | 1580 | 1580 |
| modulus (MPa) | | | | | | |
| Flexural strength | | 47 | — | 38 | 46 | 46 |
| (MPa) | | | | | | |
| Deflection | 0.45 MPa | 96 | — | 93 | 95 | 96 |
| temperature | 1.81 MPa | 59 | — | 55 | 58 | 58 |
| under load | | | | | | |
| (° C.) | | | | | | |
| Izod impact | 23° C. | 30 | — | 25 | 29 | 29 |
| strength | | | | | | |
| (J/m) | | | | | | |

### Comparative Example 6C

The injection molding was performed in the same manner as the Comparative Example 3C, except that propylene random copolymer (product name: PRIME POLYPRO J226E, manufactured by PRIME POLYMER Co., Ltd., crystal melting temperature: 160° C.) was used instead of propylene homopolymer (PRIME POLYPRO J106G), and various physical properties were evaluated. The results are shown in Table 7-A.

### Comparative Example 7C

The injection molding of propylene random copolymer (PRIME POLYPRO J226E) was tried in the same manner as the Comparative Example 6C, except that the molding temperature was changed to 190° C., but an excellent molded product was not obtained due to the short shot.

### Comparative Example 8C

To 100 parts by weight of propylene random copolymer (PRIME POLYPRO J226E), 2 parts by weight of Ziegler polyethylene wax (Hi-wax (registered trademark) 420P)) prepared by using a Ziegler catalyst was added, and then sufficiently mixed in a tumbler mixer to prepare a mixture of polypropylene and polyethylene wax.

The injection molding was performed in the same manner as the Comparative Example 6, except that the mixture was used instead of propylene random copolymer (PRIME POLYPRO J226E), the molding temperature was changed to 190° C., and the cooling time of mold was changed to 15 seconds, and various physical properties were evaluated. The results are shown in Table 7-A.

### Example 5C

The injection molding was performed in the same manner as the Comparative Example 8C, except that 2 parts by weight of metallocene polyethylene wax (EXCEREX (registered trademark) 30200BT) was used instead of Ziegler polyethylene wax (Hi-wax (registered trademark) 420P), and various physical properties were evaluated. The results are shown in Table 7-A.

### Example 6C

The injection molding was performed in the same manner as the Example 5C, except that 2 parts by weight of metallocene polyethylene wax (EXCEREX (registered trademark) 48070BT was used instead of metallocene polyethylene wax (EXCEREX (registered trademark) 30200BT), and various physical properties were evaluated. The results are shown in Table 7-A.

[Table 7-A]

TABLE 7-A

| | | Comparative | Comparative | Comparative | Example | Example |
|---|---|---|---|---|---|---|
| | | Example 6C | Example 7C | Example 8C | 5C | 6C |
| Additive amount | | 0 | 0 | 0 | 2 | ∘ |
| (parts by weight) | | | | | | |
| of EXCEREX 30200BT | | | | | | |
| Additive amount | | 0 | 0 | 0 | 0 | 2 |
| (parts by weight) | | | | | | |
| of EXCEREX 48070BT | | | | | | |
| Additive amount | | 0 | 0 | 2 | 0 | 0 |
| (parts by weight) | | | | | | |
| of Hi-wax 420P | | | | | | |
| Molding temperature | | 220 | 190 | 190 | 190 | 190 |
| (° C.) | | | | | | |
| Cooling time of | | 20 | — | 15 | 15 | 15 |
| mold (sec) | | | | | | |
| Releasability | | ◯ | — | X | ◯ | ◯ |
| Flow mark | | ◯ | — | ◯ | ◯ | ◯ |
| Tensile Yield | | 32 | — | 26 | 31 | 31 |
| Stress (MPa) | | | | | | |
| Flexural elastic | | 1170 | — | 940 | 1160 | 1170 |
| modulus (MPa) | | | | | | |
| Flexural strength | | 60 | — | 48 | 58 | 58 |
| (MPa) | | | | | | |
| Deflection | 0.45 MPa | 79 | — | 75 | 79 | 78 |
| temperature | 1.81 MPa | 53 | — | 50 | 53 | 53 |
| under load | | | | | | |
| (° C.) | | | | | | |
| Izod impact | 23° C. | 61 | — | 50 | 59 | 60 |
| strength | −20° C. | 21 | — | 15 | 21 | 21 |
| (J/m) | | | | | | |

In comparison of Examples 1C and 2C with Comparative Examples 1C and 2C, in comparison of Examples 3C and 4C with Comparative Examples 3C and 4C, and in comparison of Examples 5C and 6C with Comparative Examples 6C and 7C, it is seen that, when polyethylene wax is added, the injection molding is possible without deterioration of the properties of the molded article even in the case of lowering molding temperature by 30° C. as compared with the case of adding no polyethylene wax. It is also seen that the cooling time of mold can be reduced. In addition, in comparison of Examples 3C and 4C with Comparative Example 5C, and in comparison of Examples 5C and 6C with Comparative Example 8C, it is seen that when polyethylene wax obtained by the use of the catalyst satisfying the relation of the expression (I) between the melt viscosity and the B value and satisfying the expression (II) between the melt viscosity and the A value is added to polypropylene, the injection molded article having an excellent mechanical property can be prepared, as compared with the case of using a conventional wax, and the releasability from the mold is also excellent.

### Comparative Example 9C

The flow length of propylene block copolymer (product name: PRIME POLYPRO J704WA, manufactured by PRIME POLYMER Co., Ltd., crystal melting temperature: 160° C.) was measured under the following conditions.

(Flow Length Measurement)

By means of the mold for measuring resin flow length (1 mm in thick, 10 mm in width), the injection molding was performed by the use of an injection molding machine (manufactured by Toshiba Machine Co., Ltd., 55 ton injection molding machine (IS55EPNi1.5B)), under the conditions of resin temperature of 220° C., mold temperature of 40° C., and the flow length (spiral flow length) was measured.

Next, for the propylene block copolymer, the molded article was prepared by injection molding under the following conditions, and various physical properties were evaluated. The results are shown in Table 1.

[Condition for Injection Molding]

Injection molding machine: manufactured by Toshiba Machine Co., Ltd., 55 ton injection molding machine (IS55EPNi1.5B),

Molding temperature: 220° C.

Injection pressure: 105 MPa,

Mold temperature: 40° C.

Cooling time of mold: 20 seconds.

[Evaluation of Physical Properties]

(Releasability)

By means of the injection molding machine, under the above-described conditions (except cooling time of mold), a plane (100 mm×100 mm×3 mm in thick) was made by injection molding, and then cooled for 10 second as cooling time of mold. Thereafter, the molded article in the mold was pushed out with a pin, upon which the releasability was evaluated based on the following criteria.

◯: The molded article is demolded without resistance, but is not deformed.

x: The molded article is deformed with large release resistance due to adherence to a mold, or the like.

(Flow Mark)

A plane (100 mm×100 mm×3 mm in thick) was made by injection molding using the injection molding machine under the above-described conditions, and then flow mark was observed.

◯: The flow mark is not observed.

x: The flow mark is observed.

(Tensile Yield Stress)

A test specimen was prepared using the injection molding machine under the above-described conditions, and a tensile yield stress thereof was measured in accordance with JIS K7161.

(Flexural Elastic Modulus, and Flexural Strength)

A test specimen was prepared using the injection molding machine under the above-described conditions, and a flexural elastic modulus and a flexural strength thereof were measured in accordance with JIS K7171.

(Heat Resistance)

A test specimen was prepared using the injection molding machine under the above-described conditions, and a Vicat softening point thereof was measured in accordance with JIS K7206.

(Impact Resistance)

A test specimen was prepared using an injection molding machine under the above conditions, and an Izod impact strength thereof was measured in accordance with JIS K7110.

### Examples 7C and 8C

To 100 parts by weight of Propylene block copolymer (product name: PRIME POLYPRO J704WA, manufactured by PRIME POLYMER Co., Ltd., crystal melting temperature: 160° C.), 1 part by weight or 3 parts by weight of a metallocene polyethylene wax (EXCEREX (Registered Trademark) 30200BT, manufactured by Mitsui Chemical Inc., content of ethylene: 95 mol %, density: 913 kg/m³, average molecular weights (Mn)=2000) prepared by using a metallocene catalyst was added, and then sufficiently mixed in a tumbler mixer to prepare a mixture of the polypropylene and the polyethylene wax. The flow length of this mixture was measured in the same manner as in Comparative Example 9C. Further, this mixture was subjected to injection molding in the same manner as in Comparative Example 9C, and various physical properties thereof were evaluated. The results are shown in Table 7-B.

[Table 7-B]

TABLE 7-B

| | | Comparative | Example | Example |
|---|---|---|---|---|
| | | Example 9C | 7C | 8C |
| Additive amount of | | 0 | 1 | 3 |
| metallocene PE wax | | | | |
| (parts by weight) | | | | |
| Flow length (cm) | | 67 | 71 | 72 |
| L/L₀ | | 1 | 1.05 | 1.06 |
| Releasability | | X | ◯ | ◯ |
| Flow mark | | ◯ | ◯ | ◯ |
| Tensile yield stress (MPa) | | 32 | 31 | 30 |
| Flexural elastic modulus | | 1400 | 1400 | 1380 |
| (MPa) | | | | |
| Flexural Strength (MPa) | | 44 | 44 | 43 |
| Vicat softening point (° C.) | | 153 | 153 | 153 |
| Izod impact | −30° C. | 38 | 37 | 36 |
| strength | 23° C. | 95 | 98 | 96 |
| (J/m) | | | | |

In comparison of Examples 7C and 8C with Comparative Example 9C, it is seen that even when a polyolefin wax (metallocene wax) was added to a thermoplastic resin (polyolefin), deterioration of physical properties of an injection molded article were not perceived, and the fluidity (flow length) was improved by 5%. This indicates that a mixture of the thermoplastic resin and the polyolefin wax has improved resin flow into the fine parts of the mold, thus it allowing precision molding (molding in the shape precisely conforming to the mold). In addition, by adding a polyolefin wax, releasability from a mold is also improved, and even for thin film molding, adherence of the molded article to the mold can be avoided.

### Examples of Polypropylene Resin Mixture (1)

### Example 1D

80 parts by mass of polypropylene resin (PRIME POLYPRO J704UG; propylene block copolymer, manufactured by PRIME POLYMER Co., Ltd., density=910 (kg/m³), MI=5.0 g/10 min.), 20 parts by mass of ethylene/α-olefin random copolymer [olefin elastomer] (TAFMER A1050; manufactured by Mitsui Chemical Inc., density=860 (kg/m³), MI=1.2 g/10 min. (190° C., test load of 21.18N)), and 2 parts by mass of a metallocene polyethylene wax (EXCEREX 30200BT, manufactured by Mitsui Chemical Inc., density: 913 (kg/m3), Mn=2000, A value=9.3 (% by weight), B value=2.2 (% by weight), and melt viscosity=300 (mPa·s)) were mixed. Next, the cylinder temperature of the injection molding machine (manufactured by Toshiba Machine Co., Ltd., IS55EPNi1.5A) and the mold temperature was set to 190° C. and 40° C., respectively, the obtained mixture was placed to the injection molding machine, and the injection molding was performed under the conditions of a (primary) injection pressure: 40 MPa, an injection speed: 80 mm/sec, an injection time: 10 seconds, and a cooling time of mold: 15 second. The results are shown in Table 8.

### Example 2D

The injection molding was performed as the same manner as in the Example 1D except that the polyethylene wax was changed to metallocene polyethylene wax (EXCEREX 48070BT, manufactured by Mitsui Chemicals, Inc., density: 902 (kg/m³), Mn=3400, A value=4.7 (% by weight), B value=8.7 (% by weight), and melt viscosity=1350 (mPa·s)). The results are shown in Table 8.

### Example 3D

The injection molding was performed as the same manner as in the Example 1D except that the polyethylene wax was changed to polyethylene wax (1) (density: 897 (kg/m³), Mn=800, A value=23.5 (% by weight), B value=0.01 (% by weight), and melt viscosity=40 (mPa·s)). The results are shown in Table 8.

### Example 4D

The injection molding was performed as the same manner as in the Example 1D except that the polyethylene wax was changed to polyethylene wax (2) (density: 880 (kg/m³), Mn=2,500, A value=7.0 (% by weight), B value=4.1 (% by weight), and melt viscosity=600 (mPa·s)). The results are shown in Table 8.

### Example 5D

The injection molding was performed as the same manner as in the Example 1D except that the additive amount of metallocene polyethylene wax (EXCEREX 48070BT, manufactured by Mitsui Chemicals, Inc.) was changed to be 1 part by mass. The results are shown in Table 8.

### Example 6D

The injection molding was performed as the same manner as in the Example 1D except that the additive amount of metallocene polyethylene wax (EXCEREX 48070BT, manufactured by Mitsui Chemicals, Inc.) was changed to be 5 parts by mass. The results are shown in Table 8.

### Comparative Example 1D

80 parts by mass of polypropylene resin (PRIME POLYPRO J704UG; propylene block copolymer, manufactured by PRIME POLYMER Co., Ltd., density=910 (kg/m³), MI=5.0 g/10 min.), and 20 parts by mass of ethylene/α-olefin random copolymer [olefin elastomer] (TAFMER A1050; manufactured by Mitsui Chemical Inc., density=860 (kg/m³), MI=1.2 g/10 min. (190° C., test load of 21.18N)) were mixed. Next, the cylinder temperature of the injection molding machine (manufactured by Toshiba Machine Co., Ltd., IS55EPNi1.5A) and the mold temperature was set to 210° C. and 40° C., respectively, the obtained mixture was placed to the injection molding machine, and the injection molding was performed under the conditions of a (primary) injection pressure: 40 MPa, an injection speed: 80 mm/sec, an injection time: 10 seconds, and a cooling time of mold: 20 second. The results are shown in Table 8.

### Comparative Example 2D

80 parts by mass of polypropylene resin (PRIME POLYPRO J704UG; propylene block copolymer, manufactured by PRIME POLYMER Co., Ltd., density=910 (kg/m³), MI=5.0 g/10 min.), and 20 parts by mass of ethylene/α-olefin random copolymer [olefin elastomer] (TAFMER A1050; manufactured by Mitsui Chemical Inc., density=860 (kg/m³), MI=1.2 g/10 min. (190° C., test load of 21.18N)) were mixed. Next, the cylinder temperature of the injection molding machine (manufactured by Toshiba Machine Co., Ltd., IS55EPNi1.5A) and the mold temperature was set to 190° C. and 40° C., respectively, the obtained mixture was placed to the injection molding machine, and the injection molding was tried to be performed under the conditions of a (primary) injection pressure: 40 MPa, an injection speed: 80 mm/sec, an injection time: 10 seconds, and a cooling time of mold 15 second. However, the molded product was not obtained.

### Comparative Example 3D

The injection molding was performed as the same manner as in the Example 1D except that the polyethylene wax was changed to polyethylene wax (3) (density: 932 (kg/m³), Mn=3,000, A value=4.6 (% by weight), B value=6.7 (% by weight), and melt viscosity=1000 (mPa·s)). The results are shown in Table 8. Comparing with the polyethylene resin composition containing no wax in the Comparative Example 1D, all of a tensile yield stress, a flexural elastic modulus, and flexural strength are decreased, and an izod impact is also decreased.

### Comparative Example 4D

The injection molding was performed as the same manner as in the Example 1D except that the polyethylene wax was changed to polyethylene wax (Hi-wax 420P; manufactured by Mitsui Chemicals, Inc., density=930 (kg/m³), Mn=2,000, A value=8.3 (% by weight), B value=6.2 (% by weight), and melt viscosity=700 (mPa·s)). The results are shown in Table 8. Comparing with the polyethylene resin composition containing no wax in the Comparative Example 1D, all of a tensile yield stress, a flexural elastic modulus, and flexural strength are decreased, and a deflection temperature under load and an izod impact are also decreased. In addition, the deterioration of releasability is seen and the moldability is not excellent.

### Comparative Example 5D

The injection molding was performed as the same manner as in the Example 1D except that the polyethylene wax was changed to polyethylene wax (A-C6; manufactured by Honeywell International Inc., density=913 (kg/m³), Mn=1,800, A value=6.5 (% by weight), B value=3.3 (% by weight), and melt viscosity=420 (mPa·s)). The results are shown in Table 8. Comparing with the polyethylene resin composition containing no wax in the Comparative Example 1D, all of a tensile yield stress, a flexural elastic modulus, and flexural strength are decreased, and a deflection temperature under load and an izod impact are also decreased.

TABLE 8
Result of injection molding

| | | Ex./Cex. | | | | | | | | | | |
|---|---|---|---|---|---|---|---|---|---|---|---|---|
| | | No. | | | | | | | | | | |
| | | Ex. 1D | Ex. 2D | Ex. 3D | Ex. 4D | Ex. 5D | Ex. 6D | Cex. 1D | Cex. 2D | Cex. 3D | Cex. 4D | Cex. 5D |
| Poly- | Kind | J704UG | J704UG | J704UG | J704UG | J704UG | J704UG | J704UG | J704UG | J704UG | J704UG | J704UG |
| propylene | Amount | 80 | 80 | 80 | 80 | 80 | 80 | 80 | 80 | 80 | 80 | 80 |
| Elastomer | Kind | A1050 | A1050 | A1050 | A1050 | A1050 | A1050 | A1050 | A1050 | A1050 | A1050 | A1050 |
| | Amount | 20 | 20 | 20 | 20 | 20 | 20 | 20 | 20 | 20 | 20 | 20 |
| Poly- | Kind | 30200BT | 48070BT | Polyehtylene | Polyehtylene | 48070BT | 48070BT | | | Polyehtylene | 420P | A-C6 |
| ethylene | | | | wax | wax | | | | | wax | | |
| wax | | | | (1) | (2) | | | | | (3) | | |
| | Amount | 2 | 2 | 2 | 2 | 1 | 5 | | | 2 | 2 | 2 |

| | | | | | | | | | | | |
|---|---|---|---|---|---|---|---|---|---|---|---|
| Molding | 190 | 190 | 190 | 190 | 190 | 190 | 210 | 190 | 190 | 190 | 190 |
| temperature (° C.) | | | | | | | | | | | |
| Cooling time of | 15 | 15 | 15 | 15 | 15 | 15 | 20 | 15.0 | 15.0 | 15.0 | 15 |
| mold (sec) | | | | | | | | | | | |
| Releasability | ∘ | ∘ | ∘ | ∘ | ∘ | ∘ | ∘ | — | ∘ | x | ∘ |
| Flow mark | ∘ | ∘ | ∘ | ∘ | ∘ | ∘ | ∘ | — | ∘ | ∘ | ∘ |
| Tensile Yield | 25.1 | 25.3 | 25.6 | 24.7 | 25.4 | 24.9 | 25.5 | — | 21.9 | 21.3 | 22.2 |
| Stress (MPa) | | | | | | | | | | | |
| Flexural elastic | 998 | 1000 | 1000 | 980 | 1000 | 997 | 1000 | — | 920 | 900 | 940 |
| modulus (MPa) | | | | | | | | | | | |
| Flexural strength | 26.4 | 27.5 | 27.7 | 26.3 | 27.2 | 26.4 | 27.0 | — | 22.8 | 21.3 | 24.5 |
| (MPa) | | | | | | | | | | | |
| Deflection | 89 | 89 | 89 | 88 | 89 | 89 | 88 | — | 89 | 86 | 87 |
| temperature under | | | | | | | | | | | |
| load (° C.) | | | | | | | | | | | |
| 0.45 MPa | | | | | | | | | | | |
| Izod impact | 665 | 665 | 675 | 670 | 665 | 675 | 665 | — | 610 | 550 | 600 |
| strength (J/m) | | | | | | | | | | | |

Ex.: Example
Cex.: Comparative Example

### Example 7D

80 parts by mass of polypropylene resin (PRIME POLYPRO J704UG; propylene block copolymer, manufactured by PRIME POLYMER Co., Ltd., density=910 (kg/m³), MI=5.0 g/10 min.), 20 parts by mass of propylene/α-olefin random copolymer [olefin elastomer] (TAFMER XM7070; manufactured by Mitsui Chemical Inc., density=900 (kg/m³), MI=7.0 g/10 min. (230° C., test load of 21.18N)), and 2 parts by mass of a metallocene polyethylene wax (EXCEREX 30200BT, manufactured by Mitsui Chemical Inc., density: 913 (kg/m3), Mn=2000, A value=9.3 (% by weight), B value=2.2 (% by weight), and melt viscosity=300 (mPa·s)) were mixed. Next, the cylinder temperature of the injection molding machine (manufactured by Toshiba Machine Co., Ltd., IS55EPNi1.5A) and the mold temperature was set to 190° C. and 40° C., respectively, the obtained mixture was placed to the injection molding machine, and the injection molding was performed under the conditions of a (primary) injection pressure: 40 MPa, an injection speed: 80 mm/sec, an injection time: 10 seconds, and a cooling time of mold: 15 second. The results are shown in Table 9.

### Example 8D

The injection molding was performed as the same manner as in the Example 7D except that the polyethylene wax was changed to metallocene polyethylene wax (EXCEREX 48070BT, manufactured by Mitsui Chemicals, Inc., density: 902 (kg/m³), Mn=3400, A value=4.7 (% by weight), B value=8.7 (% by weight), and melt viscosity=1350 (mPa·s)). The results are shown in Table 9.

### Example 9D

The injection molding was performed as the same manner as in the Example 7D except that the polyethylene wax was changed to polyethylene wax (1) (density: 897 (kg/m³), Mn=800, A value=23.5 (% by weight), B value=0.01 (% by weight), and melt viscosity=40 (mPa·s)). The results are shown in Table 9.

### Example 10D

The injection molding was performed as the same manner as in the Example 7D except that the polyethylene wax was changed to polyethylene wax (2) (density: 880 (kg/m³), Mn=2,500, A value=7.0 (% by weight), B value=4.1 (% by weight), and melt viscosity=600 (mPa·s)). The results are shown in Table 9.

### Example 11D

The injection molding was performed as the same manner as in the Example 7D except that the additive amount of metallocene polyethylene wax (EXCEREX 48070BT, manufactured by Mitsui Chemicals, Inc.) was changed to be 1 part by mass. The results are shown in Table 9.

### Example 12D

The injection molding was performed as the same manner as in the Example 7D except that the additive amount of metallocene polyethylene wax (EXCEREX 48070BT, manufactured by Mitsui Chemicals, Inc.) was changed to be 5 parts by mass. The results are shown in Table 9.

### Comparative Example 6D

80 parts by mass of polypropylene resin (PRIME POLYPRO J704UG; propylene block copolymer, manufactured by PRIME POLYMER Co., Ltd., density=910 (kg/m³), MI=5.0 g/10 min.), and 20 parts by mass of propylene/α-olefin random copolymer [olefin elastomer] (TAFMER XM7070; manufactured by Mitsui Chemical Inc., density=900 (kg/m³), MI=7.0 g/10 min. (230° C., test load of 21.18N)) were mixed. Next, the cylinder temperature of the injection molding machine (manufactured by Toshiba Machine Co., Ltd., IS55EPNi1.5A) and the mold temperature was set to 210° C. and 40° C., respectively, the obtained mixture was placed to the injection molding machine, and the injection molding was performed under the conditions of a (primary) injection pressure: 40 MPa, an injection speed: 80 mm/sec, an injection time: 10 seconds, and a cooling time of mold: 20 second. The results are shown in Table 9.

### Comparative Example 7D

80 parts by mass of polypropylene resin (PRIME POLYPRO J704UG; propylene block copolymer, manufactured by PRIME POLYMER Co., Ltd., density=910 (kg/m³), MI=5.0 g/10 min.), and 20 parts by mass of propylene/α-olefin random copolymer [olefin elastomer] (TAFMER XM7070; manufactured by Mitsui Chemical Inc., density=900 (kg/m³), MI=7.0 g/10 min. (230° C., test load of 21.18N)) were mixed. Next, the cylinder temperature of the injection molding machine (manufactured by Toshiba Machine Co., Ltd., IS55EPNi1.5A) and the mold temperature was set to 190° C. and 40° C., respectively, the obtained mixture was placed to the injection molding machine, and the injection molding was tried to be performed under the conditions of a (primary) injection pressure: 40 MPa, an injection speed: 80 mm/sec, an injection time: 10 seconds, and a cooling time of mold 15 second. However, the molded product was not obtained.

### Comparative Example 8D

The injection molding was performed as the same manner as in the Example 7D except that the polyethylene wax was changed to polyethylene wax (3) (density: 932 (kg/m³), Mn=3,000, A value=4.6 (% by weight), B value=6.7 (% by weight), and melt viscosity=1000 (mPa·s)). The results are shown in Table 9. Comparing with the polyethylene resin composition containing no wax in the Comparative Example 6D, all of a tensile yield stress, a flexural elastic modulus, and flexural strength are decreased, and a deflection temperature under load and an izod impact are also decreased.

### Comparative Example 9D

The injection molding was performed as the same manner as in the Example 7D except that the polyethylene wax was changed to polyethylene wax (Hi-wax 420P; manufactured by Mitsui Chemicals, Inc., density=930 (kg/m³), Mn=2,000, A value=8.3 (% by weight), B value=6.2 (% by weight), and melt viscosity=700 (mPa·s)). The results are shown in Table 9. Comparing with the polyethylene resin composition containing no wax in the Comparative Example 6D, all of a tensile yield stress, a flexural elastic modulus, and flexural strength are decreased, and a deflection temperature under load and an izod impact are also decreased. In addition, the deterioration of releasability is seen and the moldability is not excellent.

### Comparative Example 10D

The injection molding was performed as the same manner as in the Example 7D except that the polyethylene wax was changed to polyethylene wax (A-C6; manufactured by Honeywell International Inc., density=913 (kg/m³), Mn=1,800, A value=6.5 (% by weight), B value=3.3 (% by weight), and melt viscosity=420 (mPa·s)). The results are shown in Table 9. Comparing with the polyethylene resin composition containing no wax in the Comparative Example 6D, all of a tensile yield stress, a flexural elastic modulus, and flexural strength are decreased, and a deflection temperature under load and an izod impact are also decreased.

TABLE 9
Result of injection molding

| | | Ex./Cex. | | | | | | | | | | |
|---|---|---|---|---|---|---|---|---|---|---|---|---|
| | | No. | | | | | | | | | | |
| | | Ex. 7D | Ex. 8D | Ex. 9D | Ex. 10D | Ex. 11D | Ex. 12D | Cex. 6D | Cex. 7D | Cex. 8D | Cex. 9D | Cex. 10D |
| Poly- | Kind | J704UG | J704UG | J704UG | J704UG | J704UG | J704UG | J704UG | J704UG | J704UG | J704UG | J704UG |
| pro- | Amount | 80 | 80 | 80 | 80 | 80 | 80 | 80 | 80 | 80 | 80 | 80 |
| pylene | | | | | | | | | | | | |
| Elas- | Kind | XM7070 | XM7070 | XM7070 | XM7070 | XM7070 | XM7070 | XM7070 | XM7070 | XM7070 | XM7070 | XM7070 |
| tomer | Amount | 20 | 20 | 20 | 20 | 20 | 20 | 20 | 20 | 20 | 20 | 20 |
| Poly- | Kind | 30200BT | 48070BT | Poly- | Poly- | 48070BT | 48070BT | | | Poly- | 420P | A-C6 |
| ethylene | | | | ehtylene | ehtylene | | | | | ehtylene | | |
| wax | | | | wax | wax | | | | | wax | | |
| | | | | (1) | (2) | | | | | (3) | | |
| | Amount | 2 | 2 | 2 | 2 | 1 | 5 | | | 2 | 2 | 2 |

| | | | | | | | | | | | |
|---|---|---|---|---|---|---|---|---|---|---|---|
| Molding | 190 | 190 | 190 | 190 | 190 | 190 | 210 | 190 | 190 | 190 | 190 |
| temperature (° C.) | | | | | | | | | | | |
| Cooling time of | 15 | 15 | 15 | 15 | 15 | 15 | 20 | 15 | 15 | 15 | 15 |
| mold (sec) | | | | | | | | | | | |
| Releasability | ∘ | ∘ | ∘ | ∘ | ∘ | ∘ | ∘ | — | ∘ | x | ∘ |
| Flow mark | ∘ | ∘ | ∘ | ∘ | ∘ | ∘ | ∘ | — | ∘ | ∘ | ∘ |
| Tensile Yield | 22.2 | 22.3 | 22.8 | 22.1 | 22.7 | 21.8 | 22.6 | — | 20.3 | 18.5 | 20.8 |
| Stress (MPa) | | | | | | | | | | | |
| Flexural elastic | 950 | 950 | 960 | 940 | 950 | 940 | 950 | — | 900 | 900 | 910 |
| modulus (MPa) | | | | | | | | | | | |
| Flexural strength | 24.6 | 24.6 | 24.8 | 24.2 | 25.0 | 24.1 | 25.0 | — | 21.4 | 20.5 | 22.5 |
| (MPa) | | | | | | | | | | | |
| Deflection | 86 | 85 | 86 | 86 | 88 | 87 | 88 | — | 86 | 85 | 85 |
| temperature under | | | | | | | | | | | |
| load (° C.) | | | | | | | | | | | |
| 0.45 MPa | | | | | | | | | | | |
| Izod impact | 640 | 640 | 650 | 650 | 640 | 650 | 640 | — | 610 | 600 | 630 |
| strength (J/m) | | | | | | | | | | | |

Ex.: Example
Cex.: Comparative Example

1. A process for producing an injection molded product, comprising injection molding a mixture containing a thermoplastic resin (A) and a polyolefin wax (B),
wherein the mixture has L/L₀≧1.05, the L being a flow length in the case where the mixture contains the polyolefin wax and the L₀ being a flow length in the case where the mixture contains no polyolefin wax, the L and L₀ being measured under the conditions of a mold temperature of 40° C. and a resin temperature, Tr, as determined by the following expression:
Tr=3/4×Tm+100
(wherein Tm represents a melting temperature (° C.) of the thermoplastic resin), using a spiral flow mold having a thickness of 1 mm and a width of 10 mm.

2. The process for producing an injection molded product according to claim 1, wherein the mixture comprises 0.5 to 15 parts by weight of polyolefin wax (B) based on 100 parts by weight of the thermoplastic resin (A).

3. The process for producing an injection molded product according to claim 1, wherein the polyolefin wax (B) is a polyethylene wax.

4. The process for producing an injection molded product according to claim 1, wherein the thermoplastic resin (A) is polypropylene or polyethylene.

5. A process for producing a molded product obtained by injection molding a mixture containing a thermoplastic resin (A) and a polyethylene wax having a density as measured by the density gradient tube process of JIS K7112 in the range of 880 to 980 (kg/m³) and a number-average molecular weight (Mn) in terms of polyethylene as measured by gel permeation chromatography (GPC) in the range of usually 500 to 4,000, and satisfying the relation represented by following expression (I):
B≦0.0075×K (I)
wherein B is a content ratio (% by weight) of the component having a molecular weight of 20,000 or more in terms of polyethylene in the polyethylene wax as measured by gel permeation chromatography (GPC) on the basis of the weight, and K is a melt viscosity (mPa·s) at 140° C. of the polyethylene wax.

6. The process for producing a molded product obtained by injection molding according to claim 5, wherein the polyethylene wax further satisfies the relation represented by following expression (II):
A≦230×K^{(-0.537)} (II)
wherein A is the content ratio (% by weight) of the component having a molecular weight of 1,000 or less in terms of polyethylene in the polyethylene wax on the basis of the weight, as measured by gel permeation chromatography, and K is a melt viscosity (mPa·S) at 140° C. of the polyethylene wax.

7. The process for producing a molded product obtained by an injection molding according to claim 5, wherein the thermoplastic resin (A) is polyethylene having a density as measured in accordance with the density gradient tube process of JIS K7112 in the range of 900 (kg/m³) or more to less than 940 (kg/m³), and an Ml measured under the conditions at 190° C. and a test load of 21.18N in accordance with JIS K7210 in the range of 0.01 to 100 g/10 min., and the polyethylene wax (B) has a density as measured in accordance with the density gradient tube process of JIS K7112 in the range of 890 to 980 (kg/m³).

8. The process for producing a molded product obtained by an injection molding according to claim 5, wherein the thermoplastic resin (A) is polyethylene having a density as measured in accordance with the density gradient tube process of JIS K7112 in the range of 940 to 980 (kg/m³), and an MI measured under the conditions at 190° C. and a test load of 21.18N in accordance with JIS K7210 in the range of 0.01 to 100 g/10 min., and the polyethylene wax (B) has a density as measured in accordance with the density gradient tube process of JIS K7112 in the range of 890 to 980 (kg/m³), and a number-average molecular weight (Mn) in terms of polyethylene as measured by gel permeation chromatography (GPC) in the range of 500 to 3,000.

9. The process for producing a molded product obtained by an injection molding according to claim 5, wherein the thermoplastic resin (A) is polypropylene, and the polyethylene wax (B) has a density as measured in accordance with the density gradient tube process of JIS K7112 in the range of 890 to 980 (kg/m³).

10. The process for producing a molded product obtained by an injection molding according to claim 5, wherein the thermoplastic resin (A) is a resin mixture comprising 55 to 95% by weight of polypropylene and 5 to 45% by weight of an olefin elastomer, on the basis of 100% by weight of the total amount of polypropylene and olefin elastomer, and the polyethylene wax (B) has a density as measured in accordance with the density gradient tube process of JIS K7112 in the range of 880 to 920 (kg/m³).

11. The process for producing a molded product obtained by an injection molding according to claim 5, wherein 0.01 to 10 parts by weight of the polyethylene wax (B) is contained based on 100 parts by weight of the thermoplastic resin (A).

12. An injection molded product obtained by the production method according to claim 1.

13. An injection molded product obtained by the production method according to claim 5.
